(19) United States
(12) Patent Application Publication
(10) Pub. No.: US 2023/0063745 A1
(43) Pub. Date: Mar. 2, 2023

(54) COMPOSITIONS FOR BIODEGRADABLE PLANT POTS

(71) Applicant: BIOPLASMAR LTD., Moshav Aderet (IL)

(72) Inventor: Chanoch SAMET, Moshav Aderet (IL)

(21) Appl. No.: 17/976,850

(22) Filed: Oct. 30, 2022

Related U.S. Application Data
(63) Continuation of application No. PCT/IL2021/050498, filed on Apr. 29, 2021.
(60) Provisional application No. 63/018,064, filed on Apr. 30, 2020.

(51) Int. Cl. A01G 9/02; C08J 7/04; C08J 3/28; C08L 97/02; C08L 3/02; C08L 71/14

(52) U.S. Cl. CPC A01G 9/021; C08J 7/0427; C08J 3/28; C08L 97/02; C08L 3/02; C08L 71/14; C08J 2303/02; C08J 2471/14; C08L 2201/06

(57) ABSTRACT

The present invention provides a composition comprising at least one organic component having particles between 1 and 4 mm, and a cured thermoset polymer, and wherein a w/w ratio of the organic component to the thermoset polymer within the composition is between 4:1 and 10:1. Furthermore, provided herein are articles in a form of planting pots comprising the composition of the invention. The invention also provides a method for manufacturing of planting pots.

### CROSS REFERENCE TO RELATED APPLICATIONS

This application is a Bypass Continuation of PCT Patent Application No. PCT/IL2021/050498 having International filing date of Apr. 29, 2021, which claims the benefit of priority of U.S. Provisional Patent Application No. 63/018,064, filed on Apr. 30, 2020, the contents of which are all incorporated herein by reference in their entirety.

### FIELD OF THE INVENTION

The invention relates to the field of biodegradable containers and articles for disposable use, particularly for use in agriculture, and to mixtures used in the preparation of the biodegradable articles.

### BACKGROUND OF THE INVENTION

A major source of preoccupation in modern society has been the amount of waste produced and its impact in the environment, increasing pollution and using valuable spaces as landfill. Thus, there has been great interest in the manufacture of biodegradable disposable articles, and especially when these are made from recycled or discarded material.

One application for biodegradable disposable containers is in the agricultural sector, for example in plant nurseries and green houses. Plants are grown in pots until they are mature enough to be distributed to retail outlets or to consumers. Typically, molded non-biodegradable plastic pots are used for growing plants, which end up being discarded after the plant is transplanted into the soil. The pots then end up in landfills or garbage dumps, where they remain for a very long time since they are not biodegradable.

Alternatives to conventional plastic pots exist. Biodegradable pots made of paper (cellulose fibers), peat and other organic waste are known. These pots are designed to degrade relatively quickly when buried in soil. This allows consumers to simply bury the pot with the plant in it, rather than having to remove the plant from the pot before planting. However, the biodegradable pots must also be substantially resistant to irrigation and to greenhouse conditions during the growing period, so as to prevent disintegration thereof prior to being buried in soil.

Some biodegradable pots include a thermoplastic polymer layer on top of the interior surface of the plant pot, which is exposed to soil placed in the plant pot. However, methods of irrigation and the humid environment in many nurseries cause the external surfaces of pots to be exposed to moisture, so that a sealant on the interior of a plant pot does not prevent degradation of the pot while still on the shelf in the nursery (or greenhouse).

Nurseries also use plug trays for plant transplants. In plug trays each transplant grows in an individual cell avoiding competition among plants and providing uniformity of the plants.

Planting seedlings in the field typically involves extracting each plug out of the tray and transplanting it in soil. Transplanting often causes shock due to damaged done to the roots while being extracted from the tray.

The standards by which the quality of planting is measured include placing the seedling plugs without exerting damaging pressure on the roots, evenly spacing the seedlings, planting the seedlings upright and properly covering the plugs. By these standards automated planting produces better results than manual planting. Thus, plantation nowadays is mostly automated. However, automated planting requires the use of large expensive planting machines, or cheaper machines that require the use of human labor. Furthermore, the planting machines only work efficiently in dry and broken up soils. Unfortunately, planting in dry soil in hot climates can be fatal for the young plants. Thus, farmers typically irrigate the soil before planting, which results in muddy fields which hinder the functioning of the planting machines.

### SUMMARY OF THE INVENTION

It is an object of the present invention to provide a mixture derived from organic waste and other organic components, which is used in the manufacture of biodegradable containers and articles, and in particular in the manufacture of pots and trays used for agriculture.

In one aspect, the present invention provides an article comprising an organic component, a biopolymer, and a cured thermoset polymer, wherein: a particle size of the organic component is between 1 and 4 mm; a weight per weight (w/w) ratio of the organic component to the thermoset polymer within the article is between 4:1 and 10:1; and a w/w concentration of the cured thermoset polymer within the article of the invention is between 2 and 20%.

In one embodiment, the article further comprises up to 20% w/w of an emulsifying agent.

In one embodiment, the emulsifying agent is any one of propylene glycol, glycerin, PEG, ethylene glycol, silicone oil, an alcohol, or any combination thereof

In one embodiment, the thermoset polymer comprises polyfurfuryl alcohol (PFA), polyethyleneglycol, polyester, polyepoxide including any copolymer or any combination or a copolymer thereof.

In one embodiment, the thermoset polymer comprises polyfurfuryl alcohol (PFA).

In one embodiment, a moisture content within the article is less than 5% w/w.

In one embodiment, the organic component is selected from the group consisting of wood chips, soil, saw dust, compost, biomass, and ash or any combination thereof.

In one embodiment, the biopolymer is selected from the group consisting of starch, flour, modified starch, cellulose, carboxymethylcellulose, methylcellulose, nitrocellulose, chitosan, alginate, pectin, Xanthan gum, gelatin, or any combination thereof.

In one embodiment, the composition comprises wood chips, compost, cured PFA and flour or any combination thereof.

In one embodiment, the article is in a form of a container.

In one embodiment, the article is a planting article.

In one embodiment, the article is stable under greenhouse conditions for a predefined time period ranging between 2 weeks and 10 months.

In one embodiment, the article is biodegradable or bioerodible upon exposure to soil.

In one embodiment, the article is characterized by a predetermined degradation time suitable for supporting growth of a plant upon transplantation.

In one embodiment, supporting comprises any one of: (i) preventing damage to a plant root, and (ii) facilitating root propagation and penetration of salts, water, and air through a wall of the article.

In one embodiment, the article has thickness of between 1.5 and 4 mm.

In one embodiment, the article further comprises a coating layer.

In one embodiment, the coating layer comprises a biodegradable polymer.

In another aspect, there is provided a process for manufacturing the article of the invention, comprising the steps of: providing a mixture of the invention comprising the organic component and a curable resin, at a w/w ratio between 4:1 and 20:1, wherein a moisture content of the organic component is between 8 and 20% w/w, and wherein the mixture comprises a catalyst; and molding the mixture under suitable conditions, thereby manufacturing the article.

In one embodiment, suitable conditions comprise exposing the mixture to (i) a pressure and (ii) a thermal radiation.

In one embodiment, the thermal radiation is sufficient for curing the curable resin.

In one embodiment, the curable resin comprises furfuryl alcohol resin.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

In addition to the exemplary aspects and embodiments described above, further aspects and embodiments will become apparent by reference to the study of the following detailed description.

### BRIEF DESCRIPTION OF THE FIGURES

The patent or application file contains at least one drawing executed in color. Copies of this patent or patent application publication with color drawing(s) will be provided by the Office upon request and payment of the necessary fee

FIG. 1 schematically illustrates a plant pot according to non-limiting embodiments of the invention.

FIGS. 2A-2B schematically illustrate biodegradable trays according to a non-limiting embodiment of the invention.

FIGS. 3A-3B schematically illustrate a rigid biodegradable planting receptacle which may be used to facilitate automated planting, according to an embodiment of the invention (3A) and a non-limiting method of automated planting (3B).

FIG. 4 is a photograph showing root breakage through the wall of an exemplary plant pot of the invention about 4 weeks after planting thereof into the soil.

FIG. 5 is a bar graph representing the amount of nitrogen released from an exemplary article of the invention over time. The experimental data was obtained by performing a mineralization test (according to FD U44-163).

FIG. 6 is a bar graph representing the amount of carbon released from an exemplary article of the invention over time. The experimental data was obtained by measuring cumulative mineralization of carbon by mineralization test (according to FD U44-163).

### DETAILED DESCRIPTION OF THE INVENTION

The present invention is related, in some embodiments thereof, to a composition comprising organic material and a cured polymeric matrix. In one embodiment, the cured polymeric matrix provides elasticity and improved mechanical stability to the composition, thus making it suitable for manufacturing of at least partially degradable and/or bio erodible containers or planting articles. The compositions and articles, described herein, have been optimized for use in cultivation of annual and/or perennial crop plants, trees, and/or ornamental plants, including any combination thereof.

In one aspect, the present invention provides at least an article including but not limited to plant pots and other containers (e.g. planting articles), being partially degradable or biodegradable, for use in agriculture, the article comprise biomass (such as wood-waste and soil) and a cured polymer (or an adhesive), optionally coated with biopolymers. In one embodiment, the article of the invention is biodegradable and/or bio erodible and recyclable. In one embodiment, the article of the invention is substantially stable to various irrigation techniques under greenhouse conditions for a predefined period of between 2 weeks and 10 months.

In some embodiments, the article of the invention is configured to retain at least 80%, at least 90%, at least 95% of the geometrical shape and/or physical properties thereof under greenhouse conditions, and is further configured to undergo a gradual degradation or erosion upon contact thereof with soil (e.g. by planting in an open field). In some embodiments, the article of the invention is characterized by a degradation profile adopted for cultivation of annual plants and/or perennial plants. In some embodiments, the article of the invention is configured to support growth of a young plant in a soil, thus preventing mechanical or biological damage (e.g. by a pest) to the plant roots on and post planting; and to facilitate plant roots growth (or breakthrough) through a wall of the article. In some embodiments, the article of the invention comprising a cultured plant is configured to substantially retain its function as a container (e.g. by at least partially retaining its geometrical shape so as to enclose at least 80% of the plant roots) upon transplanting thereof into the soil, for a time period sufficient for acclimatization of the plant within the soil.

In one embodiment, an exemplary planting article of the invention is or comprises a biodegradable plant pot, and is configured to undergo biodegradation and/or bio erosion in-situ at a planting site (e.g. soil). In one embodiment, the article disclosed herein is at least partially degradable or erodible pot and is configured to release an active agent, such as nutrient(s), fertilizer(s), anti-mold agent(s), anti-fungal agent(s), pesticide(s) and/or herbicide(s) at a planting site (e.g. soil), so as facilitates soil enrichment with the active agent.

In some embodiments, the plant pots described herein may be utilized in automated planting process and remain within the planted soil. In some embodiments, the pot at least partially disintegrates after planting and further enriches the planted soil with nutrient and plant growth stimulators. In another embodiment, the invention also provides a method for automatically planting a plant, by using an automatic planting container fitted for automatic planting, filled with biodegradable planting pots of the invention. In another embodiment, the phrases “an automatic planting container” and “a container fitted for automatic planting” are readily understood by one of skill in the art and include mechanized agricultural and gardening methods that often involve mass planting of pots placed in a container adapted to fit the mechanized method.

The invention, according to one embodiment, presents the means for receiving plants in the nursery which can be later transferred to the field or garden without the need for removing and collecting the pot prior to transplanting; plant and pot become one unit: “plant-pot”. In addition to operational and environmental advantages, the exemplary article of the invention optionally together with a plant (i) provides a protective environment to the plant roots during the sensitive post-planting period; (ii) in the course of the development of the plant, the article is degraded by soil microorganisms, thus incorporating plant nutrients into the soil; and (iii) optionally provides a potential carrier for plant nutrients and pesticides of chemical and/or biological origin.

One major advantage of the container manufactured with the mixture provided by the invention is its decomposition/erosion and integration with the soil organic matter, after its role as a container ends. In some embodiments, the composition of the invention is a shapeable composition suitable for manufacturing of an exemplary article of the invention by molding (e.g. compression molding process). In some embodiments, the composition of the invention is moldable and is characterized by elasticity sufficient for shaping or manufacturing of an exemplary article of the invention. In some embodiments, the article of the invention described herein has improved mechanical properties, so as provide a sufficient stability to a plant planted within a soil.

### Cured Composition

In one aspect of the present invention, provided herein a composition comprising an organic component and a polymer, wherein a particle size of the organic component is between 1 and 4 mm, and wherein a weight per weight (w/w) ratio of the organic component to the polymer within the composition is between 4:1 and 10:1, and wherein the polymer is at least partially cured.

In another aspect, there is provided a composition comprising an organic component and a cured thermoset polymer, wherein a particle size of the organic component is between 1 and 4 mm, and wherein a w/w ratio of the organic component to the thermoset polymer within the composition is between 4:1 and 10:1. In some embodiments, the polymer or the thermoset polymer is a cured polymer or a cured polymeric resin (also refers to herein, as “resin”).

In some embodiments, the composition of the invention comprises a cured polymer. In some embodiments, the composition of the invention comprises a cured thermoset polymer. In some embodiments, the composition of the invention is a cured composition. As used herein, the term “cured composition” and the term “composition” are used herein interchangeably and refer to a composition which has been hardened by curing, wherein “curing” is as described hereinbelow.

In one aspect of the present invention, there is provided herein a composition comprising an organic component (e.g. compost), a biopolymer (e.g. flour) and a polymer, and wherein a w/w concentration of the polymer within the composition of the invention is at least 2%, or at least 4% including any range between; and wherein the polymer is at least partially cured.

In some embodiments, the composition of the invention comprises at least one organic component (e.g. compost), a biopolymer (e.g. flour) and a polymer, wherein a w/w ratio between the at least one organic component and the biopolymer within the composition is between 2:1 and 1:2; wherein a w/w concentration of the polymer within the composition is at least 2%, or at least 4% including any range between; and wherein the polymer is at least partially cured.

In some embodiments, the composition of the invention comprises at least one organic component (e.g. compost) characterized by a particle size of between 1 and 4 mm including any range between, a biopolymer (e.g. flour) and a polymer, wherein a w/w ratio between the at least one organic component and the biopolymer within the composition is between 2:1 and 1:2; wherein a w/w concentration of the polymer within the composition is at least 2%, or at least 4% including any range between; and wherein the polymer is at least partially cured.

In some embodiments, the composition of the invention comprises (i) at least one organic component (e.g. compost) characterized by a particle size of between 1 and 4 mm including any range between; (ii) a biopolymer (e.g. flour) being optionally in a particulate form, and characterized by a particle size of at most 1 mm, at most 0.5 mm, at most 0.3 mm, at most 0.2 mm including any range between; and (iii) a polymer, wherein a w/w ratio between the at least one organic component and the biopolymer within the composition is between 2:1 and 1:2 including any range between; wherein a w/w concentration of the polymer within the composition is at least 2%, or at least 4% including any range between; and wherein the polymer is at least partially cured.

In some embodiments, the composition of the invention comprises (i) an organic component selected from compost and at least one of wood chips, bark and saw dust, and wherein the organic component is characterized by a particle size of between 1 and 4 mm including any range between; (ii) at least one biopolymer (e.g. flour) being optionally in a particulate form, and characterized by a particle size of at most 1 mm, at most 0.5 mm, at most 0.3 mm, at most 0.2 mm including any range between; and (iii) a cured polymer, wherein a w/w ratio between the organic component and the biopolymer within the composition is between 5:1 and 2:1 including any range between; wherein a w/w concentration of the polymer within the composition is at least 2%, or at least 4% including any range between; wherein a w/w ratio of the organic component to the cured polymer within the composition is between 4:1 and 10:1 including any range between. It is postulated, that implementation of a first particulate such as compost, comprising coarse particles, and of a second particulate, such as flour comprising fine particles within the uncured composition (also used herein as “the mixture”), results in the formation of articles with advantageous stability and advantageous mechanical properties.

In some embodiments, a w/w concentration of the polymer of the invention (e.g. the cured polymer, the cured thermoset polymer and/or the cured resin) within the composition of the invention is at least 2%, at least 3%, at least 4%, at least 5%, at least 7%, at least 9%, at least 12%, at least 15%, at least 20%, including any range therebetween. Without being bound to any particular theory or mechanism, it is postulated that a w/w concentration of the polymer of the invention (or cured thermoset polymer of the invention) being of at least 2%, at least 3%, at least 4%, at least 5% from the total weight of the composition of the invention (or cured composition), resulted in the formation of stable articles (such as planting containers). As demonstrated in the Examples section, articles having a w/w content of the cured thermoset polymer of the invention less than 2% are not sufficiently stable, and thus cannot be utilized as planting containers. The inventors successfully manufactured exemplary articles of the invention comprising 2%, about 4%, about 5% by weight of the cured polymer of the invention. Furthermore, articles comprising up to 20% by weight of the cured polymer of the invention have been successfully manufactured. The resulting articles were characterized by sufficient stability and exhibited a predetermined degradation profile in soil.

Polymer

In some embodiments, the composition of the invention comprises one or more polymers. In some embodiments, the polymer within the cured composition is a cured polymer. In some embodiments, the cured polymer of the invention is at least partially cross-linked. In some embodiments, the cured polymer is covalently cross-linked.

In some embodiments, the cured polymer is characterized by a cross-linking degree of between 1 and 99%, between 1 and 10%, between 10 and 20%, between 20 and 30%, between 30 and 40%, between 40 and 50%, between 50 and 70%, between 70 and 90%, including any range between.

As used herein, the term “crosslinking degree” refers to a mole ratio between the cross-links and the repeating unit of the polymer of the invention.

As used herein, the term “cured polymer” refers to a polymeric material comprising a plurality of covalently cross-linked polymeric chains. The cross-links are formed or induced by curing of the uncured polymer (e.g. exposing the uncured polymer to conditions suitable for curing). Upon cross-linking the polymer undergoes hardening. In some embodiments, the cured polymer refers to a polymer which has been irreversibly hardened by curing, such as thermoset or thermosetting polymer, also used herein as “cured thermoset polymer”.

Such crosslinking may result in the formation of a tridimensional polymeric network. In some embodiments, a thermal curing induces or initiates thermal cross-linking of the uncured polymer. In some embodiments, a thermal curing induces or initiates a nucleophilic inter-, or intra-molecular reaction, resulting in a cross-linking of the uncured polymer. In some embodiments, a nucleophilic reaction is initiated by cationic or anionic catalysis. In some embodiments, curing refers to UV-induced crosslinking of the unsaturated moieties, such as carbon-carbon double bonds of the uncured polymer. In some embodiments, curing refers to polymerization.

Cross-linking or curing can be carried out in any manner, such as for instance, irradiating with electromagnetic or thermal radiation having sufficient energy to initiate a polymerization or cross-linking reaction. Various curing techniques are well-known in the art.

In some embodiments, the w/w concentration of the cured polymer (e.g. thermoset polymer) within the composition of the invention is at least 20%, at least 15%, at least 13%, at least 10%, at least 9%, at least 8%, at least 7%, at least 5%, at least 3%, at least 2%, including any range therebetween.

In some embodiments, the w/w concentration of the thermoset polymer within the composition is at most 30%, at most 25%, at most 20%, at most 15%, at most 13%, at most 10%, at most 9%, at most 8%, at most 7%, at most 5%, at most 3%, including any range therebetween.

In some embodiments, the composition of the invention comprising more than 30% w/w of the cured thermoset polymer (such as PFA) is substantially non-erodible or non-biodegradable. In some embodiments, the composition of the invention comprising more than 20% w/w of the cured thermoset polymer (such as PFA) is substantially non-erodible or non-biodegradable. In some embodiments, the composition comprising more than 20% w/w, or more than 30% w/w of the cured thermoset polymer (such as PFA) exhibits less than 10%, less than 8%, less than 5%, less than 3% degradation for a time period ranging from 0.5 to 12 months, from 0.5 to 1 month, from 1 to 2 month, form 2 to 3 month, from 3 to 4 month, from 4 to 5 month, from 5 to 7 month, from 7 to 10 month, from 10 to 12 months, from 12 to 24 months, including any range between.

In some embodiments, the cross-linking degree of the cured polymer within the cured composition is predetermined by processing conditions (such as curing temperature, and time). In some embodiments, the cross-linking degree of the cured polymer is predetermined by a w/w ratio between the catalyst (or hardener) and the resin. For example, longer curing time and/or greater concentration of the catalyst within the mixture or uncured composition of the invention, as described hereinbelow, will result in enhanced cross-linking degree of the cured polymer. In some embodiments, the curing conditions (such as temperature, curing time and compression force) during the processing of the mixture of the invention, predetermine the cross-linking degree of the cured polymer.

In some embodiments, the thermoset polymer comprises a biocompatible thermoset polymer. In some embodiments, the thermoset polymer comprises a biodegradable polymer. In some embodiments, the thermoset polymer comprises a biocompatible and biodegradable polymer. As used herein, thermoset polymer is related to a cross-linkable polymer that is hardened (i.e. cross-linked) by exposing the polymer to UV/vis radiation or to thermal radiation, such as a temperature between 50 and 200° C. for a time period between 10 min and 2 hours. In some embodiments, the thermoset polymer comprises a thermoset resin. In some embodiments, the thermoset resin is biocompatible.

The term “resin”, as described herein is referred to a composition or a material which can be polymerized or cured upon sufficient conditions (e.g. thermal and/or UV exposure). In some embodiments, the resin comprises a monomeric chemical species, such as a chemical species having one or more functional groups or moieties that can react with the same or different functional groups or moieties of another monomeric chemical species to form one or more covalent bonds, such as in a polymerization reaction. A polymerization reaction, in some embodiments, comprises a free radical polymerization.

Optionally, the term “resin” refers to a composition comprising at least one of: a monomer, an oligomer, a polymer, or a mixture thereof, wherein the composition is at least partially polymerizable (e.g. via free-radical polymerization) upon exposure to thermal energy.

In some embodiments, the thermoset polymer comprises polyfurfuryl alcohol (PFA), polyethyleneglycol, a polyester, a polyepoxide or any combination thereof

In some embodiments, the thermoset polymer comprises PFA.

In some embodiments, the composition comprises the thermoset polymer in a cured form, also referred to herein as “cured thermoset polymer”. In some embodiments, the cured thermoset polymer is a solid. In some embodiments, the cured thermoset polymer comprises a plurality of cross-linked polymeric chains. In some embodiments, cross-linking comprises a covalent cross-linking. In some embodiments, the cured thermoset polymer is in a form of an interpenetrating network. In some embodiments, the cured thermoset polymer is in a form of a polymeric matrix comprising an interpenetrating network of cross-linked polymeric chains.

In some embodiments, the composition comprises the polymeric matrix in contact with the organic waste component. In some embodiments, the composition comprises the polymeric matrix in contact with a plurality of organic waste components. In some embodiments, the organic component is bound to the polymeric matrix. In some embodiments, the organic component is incorporated within the polymeric matrix. In some embodiments, the organic component is embedded into the polymeric matrix. In some embodiments, the organic component is adhered to the polymeric matrix. In some embodiments, the organic component is adsorbed onto the polymeric matrix.

In some embodiments, the polymeric matrix provides an adhesive for a plurality of particles of the organic component and/or for the particles of the biopolymer. In some embodiments, the polymeric matrix reinforces the composition. In some embodiments, the plurality of particles of the organic component and/or the particles of the biopolymer are held together by the polymeric matrix. In some embodiments, the components (e.g. the organic component, the biopolymer) of the composition of the invention are homogenously distributed within the polymeric matrix. In some embodiments, the polymeric matrix provides a sufficient elasticity to the composition. In some embodiments, the polymeric matrix is a plasticizer. In some embodiments, the polymeric matrix prevents cracking of the composition or the article of the invention. In some embodiments, the polymeric matrix provides sufficient mechanical stability to the composition or to the article of the invention, wherein sufficient stability is as described herein.

In some embodiments, the components of the composition (e.g. the cured polymer, at least one organic component, and at least one biopolymer) are uniformly distributed therewithin. In some embodiments, the composition of the invention is in a form of a composite material or of a solid composite. In some embodiments, the entire composition or composite is substantially homogenous.

As used herein, “composite material” is a material produced from two or more constituent materials with notably dissimilar chemical or physical properties that, when merged, create a material with properties, unlike the individual elements.

In some embodiments, the homogenous composite is referred to a material which cannot be easily separated into individual constituents (e.g., the polymer, the emulsifier, the organic material, and the biopolymer of the invention).

In some embodiments, at least 50%, at least 80%, at least 85%, at least 90%, at least 93%, at least 95%, at least 97%, at least 99% including any range between, by total dry weight of the biopolymer is bioerodible.

Organic Component

In some embodiments, the composition of the invention comprises at least one organic component. In some embodiments, the composition of the invention comprises two or more types of organic components. In some embodiments, a w/w ratio of the organic component to the thermoset polymer within the composition ranges between 1:1 to 15:1, between 1:1 to 3:1, between 3:1 to 4:1, between 4:1 to 5:1, between 5:1 to 6:1, between 6:1 to 7:1, between 7:1 to 8:1, between 8:1 to 10:1, between 10:1 to 12:1, between 12:1 to 15:1, including any range therebetween.

In some embodiments, a w/w concentration of the organic component within the composition of the invention is between 20 and 50%, between 20 and 30%, between 30 and 40%, between 40 and 50%, between 50 and 70%, between 70 and 90%, including any range therebetween.

In some embodiments, the organic component comprises plant material or parts of plant material. In some embodiments, the organic component comprises wood residues. Various wood residues are well-known in the art. In some embodiments, the organic component is characterized by a greater degradation time, as compared to the greater degradation time of the biopolymer of the invention.

In some embodiments, the organic component comprises one or more particles characterized by slow degradation (such as wood chips, ash, bark, etc.) and one or more particles characterized by fast degradation (such as compost). In some embodiments, a w/w ratio between particles characterized by a slow degradation and particles characterized by fast degradation is between 3:1 and 1:1, between 3:1 and 2:1, between 2:1 and 1:1, including any range therebetween.

In some embodiments, the organic component comprises a material having a high cellulose content. In some embodiments, the cellulose content, as used herein, is related to cellulose, hemicellulose and lignin or any combination thereof

In some embodiments, the organic component has a cellulose content of at least 40%, at least 50%, at least 60%, at least 70%, at least 75%, at least 80%, at least 85%, at least 90%, at least 92%, at least 95%, at least 97%, at least 99%, including any range between.

In some embodiments, the organic component is any one of wood chips, sawdust, soil, dirt, lop, grass clippings, leaves, hay, straw, shredded bark, whole bark nuggets, sawdust, shells, woodchips, shredded paper, cardboard, wool, peat, hemp biomass, coffee residues, wood ash or other organic material ash, or any combination thereof.

In some embodiments, the organic component and/or the composition of the invention is substantially devoid of lignin.

In some embodiments, the organic component further comprises an inorganic salt, such as sodium chloride, potassium/sodium carbonate, sodium hydroxide, ammonium salt, nitrate salt, phosphate salt, or a combination thereof.

In one embodiment, soil is compost. In one embodiment, a composition as described herein comprises cellulose and/or a cellulose derivative.

In some embodiments, the organic component comprises particles having a particle size between 1 and 4 mm, between 2 and 4 mm, between 1 and 2 mm, between 2 and 3 mm, between 3 and 4 mm, including any range therebetween.

In some embodiments, the organic component comprises particles having a particle size less than 2.8 mm, less than 2.5 mm, less than 2.3 mm, less than 2.1 mm, including any range therebetween.

In one embodiment of the invention, the organic component comprises particles with a particle size about 2 mm. In one embodiment of the invention, the organic component comprises particles that are equal to or smaller than 2.8 mm. In one embodiment of the invention, the organic component comprises particles that are equal to or smaller than 2.5 mm. In one embodiment of the invention, the organic component comprises particles that are equal to or smaller than 2.2 mm. In one embodiment of the invention, the organic component comprises particles that are equal to or smaller than 2 mm. In one embodiment of the invention, more than 80% of the organic component particles are characterized by a particle size of about 2 mm (i.e. ±10%). In one embodiment of the invention, more than 85% of the organic component particles are characterized by a particle size of about 2 mm (i.e. ±10%). In one embodiment of the invention, more than 90% of the organic component particles are characterized by a particle size of about 2 mm (i.e. ±10%). In one embodiment of the invention, more than 95% of the organic component particles are characterized by a particle size of about 2 mm (i.e. ±10%).

In one embodiment of the invention, at least 90%, at least 92%, at least 95%, at least 97%, at least 99%, of the organic component comprises any of wood chips, compost, or both.

In one specific embodiment, the organic component is a mixture of any two or more components selected from: wood chips, soil, ash, compost, biomass, and saw dust. In some embodiments, the organic component is a mixture of wood chips and/or saw dust and compost. The inventors successfully utilized a mixture of (i) compost and (ii) wood chips and/or saw dust for the fabrication of exemplary articles or compositions of the invention.

In some embodiments, compost is any compost known to one of average skill in the art. In some embodiments, compost refers to any aerobically degraded organic material. In some embodiments, compost is the result of Grub composting. In another embodiment, compost is Bokashi compost. In another embodiment, a compost comprises EM1 (lactic acid bacteria, yeast and phototrophic (PNSB) bacteria). In one preferred embodiment, the organic component comprises compost and wood chips, and optionally saw dust. In one preferred embodiment, the organic component comprises compost, wood chips and up to 10% w/w of a biopolymer (e.g. lignin), wherein the ratio of wood chips to compost is as described herein.

In some embodiments, a w/w ratio of wood chips to compost is between 4:1 and 1:1, between 4:1 and 3:1, between 3:1 and 2:1, between 2:1 and 1:1, including any value or range therebetween. In some embodiments, the ratio between wood chips and compost predetermines the degradation time (in the soil) of the composition and/or article of the invention.

In another embodiment, compost is a compost tea. In another embodiment, compost is Hügelkultur. In another embodiment, compost comprises Humanure. In another embodiment, compost is Vermicompost.

According to some embodiments of the invention the organic component includes material having different sized particles. The particles may be between 0.125 mm and 2mm in size, or greater than 2 mm.

In some embodiments, particle size of the organic component is about 2 mm. Without being bound to any particular theory, particles having a size of more than 2.5 mm did not result in a compressible composition suitable for manufacturing an article of the invention.

In some embodiments, the soil is rich in clay. Clay is the most active mineral component of soil. It is a colloidal and crystalline material. In soils, clay is defined in a physical sense as any mineral particle less than two microns in effective diameter. Clay is now known to be a precipitate with a mineralogical composition different from its parent materials and is classed as a secondary mineral. The type of clay that is formed is a function of the parent material and the composition of the minerals in solution. The clays of soil are a mixture of the various types of clay (crystalline, amorphous or sesquioxide) but one type predominates. One example of an ideal soil to be employed in the mixture of the invention is the soil found in Northwestern Europe, e.g. in Germany.

Biopolymer

In some embodiments, the composition of the invention comprises at least one biopolymer. In some embodiments, the composition of the invention comprises two or more types of biopolymers. In some embodiments, the composition of the invention comprises at least one biopolymer and further comprises at least one emulsifying agent.

In some embodiments, the w/w concentration of the biopolymer within the composition of the invention is at most 40%, at most 35%, at most 30%, at most 25%, at most 20%, at most 15%, at most 10%, at most 8%, at most 5%, including any range therebetween.

In some embodiments, the w/w concentration of the biopolymer within the composition of the invention is between 10 and 45%, between 10 and 20%, between 20 and 40%, between 20 and 30%, between 30 and 40%, including any range therebetween. In some embodiments, the w/w concentration of the biopolymer within the composition of the invention is between 30 and 20%.

In some embodiments, the biopolymer is a polysaccharide, or a polyamino acid (e.g. a peptide, or a protein). In some embodiments, the biopolymer is a natural or a synthetic polymer. In some embodiments, the biopolymer is derived (e.g. via chemical and/or biochemical modification, such as alkylation, phosphorylation, glycosylation, acetylation, etc.) from a natural polymer.

In some embodiments, the biopolymer is selected from the group consisting of flour, lignin, starch, modified starch, cellulose, carboxymethylcellulose, carboxyethyl cellulose, methylcellulose, ethylcellulose, nitrocellulose, chitosan, alginate, pectin, Xanthan gum, gelatin, or any combination thereof.

In some embodiments, the biopolymer is a polysaccharide. In some embodiments, the polysaccharide is selected from flour, lignin, starch, modified starch, cellulose, carboxymethylcellulose, carboxy ethylcellulose, methylcellulose, ethylcellulose, nitrocellulose, chitosan, alginate, pectin, Xanthan gum, or any combination thereof.

In some embodiments, the biopolymer is flour. In some embodiments, the biopolymer (e.g. flour) enhances adhesiveness of the composition. In some embodiments, the biopolymer enhances the structural stability of the composition or the article. In some embodiments, the biopolymer enhances the mechanical strength of the composition or the article. In some embodiments, the biopolymer (e.g. flour) enhances shapeability of the mixture of the invention. In some embodiments, the biopolymer (e.g. flour) enhances the adhesion of the components within the mixture of the invention to the thermoset polymer. In some embodiments, the biopolymer (e.g. flour) increases the degradability of the composition or article. In some embodiments, the biopolymer (e.g. flour) reduces degradation period (e.g. upon planting in soil) of the composition or of the article of the invention.

In some embodiments, the w/w ratio between the biopolymer (e.g. flour) and the organic component (e.g. fast degradable organic component, such as compost) within the composition of the invention is between 3:1 and 1:3, between 3:1 and 2:1, between 2:1 and 1.5:1, between 1.7:1 and 1.5:1, between 1.5:1 and 1.3:1, between 1.3:1 and 1.1:1, between 1.1:1 and 1:1, between 1:1 and 1:1.3, between 1:1.3 and 1:1.5, between 1:1.5 and 1:2, between 1:1 and 1:2, between 1:2 and 1:3, including any range between. In some embodiments, the w/w ratio between the flour and the compost within the composition of the invention is between 1.5:1 and 1:1.5 including any range between.

In some embodiments, the one or more biopolymers of the invention is substantially biodegradable and/or bioerodible. In some embodiments, at least 80%, at least 85%, at least 90%, at least 93%, at least 95%, at least 97%, at least 99% by total dry weight of the biopolymer is biodegradable.

In some embodiments, the w/w ratio between the biopolymer (e.g. flour) and the total content of the organic component (e.g. fast degradable organic component, such as compost and slow degradable organic component such as wood chips) within the composition of the invention is between 5:1 and 1:1, between 5:1 and 4:1, between 4:1 and 2:1, between 4:1 and 3:1, between 3:1 and 2:1, between 2:1 and 1.5:1, between 1.5:1 and 1:1, including any range between.

In some embodiments, the composition of the invention optionally comprises flour and an additional biopolymer. In some embodiments, the w/w concentration of the additional biopolymer (e.g. lignin) within the composition is between 0.5 and 10%, between 0.5 and 1%, between 1 and 2%, between 2 and 2.5%, between 2.5 and 3%, between 3 and 4%, between 4 and 5%, between 5 and 7%, between 7 and 10%, including any range between.

Flour is known for its adhesive properties. It is to be understood that the term “flour” may include any one of wheat flour, flour from grains, such as those chosen from buckwheat flour, semolina flour, corn flour, corn starch, corn sledge, rice flour, tapioca flour, potato flour, soy flour, ground flax meal, flax flour, hemp flour, and any mixtures thereof

In some embodiments, the at least one emulsifying agent (also used herein as a “wetting agent”) comprises any one of propylene glycol (PG), glycerin, polyethylene glycol (PEG), ethylene glycol, polysiloxane, polysilane, polyvinylpyrrolidone, polyvinyl alcohol, silicone oil, or any combination thereof. In some embodiments, the wetting agent as used herein enhances wettability of the organic component (e.g. by the uncured thermoset polymer). In some embodiments, the wetting agent enhances flexibility or elasticity of the organic waste component. In some embodiments, the emulsifying or the wetting agent comprises a high boiling point polar solvent (such as DMSO, DMF, propanol, butanol, pentanol, etc.).

The emulsifying agent (such as glycerol or any of its appropriate equivalent thereof) provides a certain degree of flexibility, stretch ability or elasticity to the mixture of the invention, which translates into shock-resistance properties of the articles or containers manufactured by utilizing the mixture of the invention. This property may be particularly relevant during the manufacturing process, but also when the articles or containers are stored and/or transported to and from retailers. In some embodiments, the emulsifying agent is used according to the invention as a humectant.

In some embodiments, the w/w concentration of the emulsifying agent (e.g. glycerol or PG) within the composition of the invention is between 0.5 and 10%, between 0.5 and 1%, between 1 and 2%, between 2 and 2.5%, between 2.5 and 3%, between 3 and 4%, between 4 and 5%, between 5 and 6%, between 6 and 7%, between 7 and 10%, including any range between.

In some embodiments, one or more emulsifying agents of the invention facilitates or enhances stability of the article of the invention (e.g. enhancement of at least 50%, at least 100%, at least 500%, at least 1000%, at least 5000%, at least 10.000%, at least 100.000%, as compared to a similar article being devoid of the emulsifying agent), such as upon prolonged storage (e.g. for a time period ranging from 1 month (m) and 10 years (y), under regular storage conditions) and/or upon exposure of the article to greenhouse conditions (e.g. humidity, irrigation, temperature), for a time period of at least 3 weeks, at least 1 m, at least 2 m, at least 3 m, at least 4 m, at least 5 m, at least 7 m, at least 10 m, at leastly, at least 2y, including any range between.

As used herein, the term “irrigation” refers to any known irrigation technique, such as drip irrigation, sprinkler irrigation, drip irrigation, surface irrigation, subsurface irrigation, or any combination thereof.

In some embodiments, the emulsifying agent of the invention facilitates or enhances stability of the article of the invention (e.g. substantially preventing cracking of the article), such as upon prolonged storage and/or upon exposure of the article to greenhouse conditions, and/or upon exposure of the article (e.g. in a form of a plant pot) to cultivation conditions for a time period of at least 3 weeks, at least 1 m (e.g. applicable for vegetables), at least 2 m, at least 3 m, at least 4 m(e.g. applicable for annual ornamental plants), at least 5 m, at least 7 m (e.g. applicable for trees), at least 10 m, at leastly, at least 2 y, including any range between. In some embodiments, cultivation conditions comprise exposure to any of soil or a growth medium, irrigation, plant treatments (e.g. application of agrochemicals such as pesticides, growth stimulating agents, etc.) temperature as described herein, rhizosphere (including inter alia soil microbiome), or a combination thereof In some embodiments, cultivation conditions relate to open field cultivation of a plant (e.g. a crop or a tree).

In some embodiments, the emulsifying agent of the invention facilitates or enhances stability of the article of the invention by substantially preventing or reducing (e.g. at least 50%, at least 100%, at least 500%, at least 1000%, at least 5000%, at least 10.000%, at least 100.000% reduction, as compared to a similar article being devoid of the emulsifying agent) cracking of the article.

In some embodiments, cultivation conditions refer to cultivation in a greenhouse, in contrast to open field cultivation.

In some embodiments, the composition of the invention comprises at least one biopolymer (e.g. flour), at least two organic components (e.g. compost, and wood chips or saw dust), and between 2 and 20% w/w of the cured polymer of the invention, wherein a w/w ratio between the biopolymer and the least two organic components is between 1:2 and 1:4. In some embodiments, the composition of the invention comprises between 20 and 30% w/w flour, between 20 and 30% w/w compost, between 35 and 45% w/w wood chips or saw dust, and between 2 and 20% w/w, or between 4 and 10% w/w of the cured polymer of the invention.

In some embodiments, at least 80%, at least 85%, at least 90%, at least 93%, at least 95%, at least 97%, at least 99% by total dry weight of the composition of the invention consist of the components, as described herein (e.g. the biopolymer, the cured polymer, the organic component, and optionally the emulsifying agent), including nay range between.

In some embodiments, the composition of the invention further comprises an additive selected from a dye, a pigment, a scent, a pesticide, a growth hormone, a fertilizer, mucilage, a preservative, sorbic acid or a salt thereof or any combination thereof.

In some embodiments, the w/w concentration of the additive within the composition of the invention is between 0.5 and 10%, between 0.1 and 0.5%, between 0.5 and 1%, between 1 and 2%, between 2 and 2.5%, between 2.5 and 3%, between 3 and 4%, between 4 and 5%, between 5 and 6%, between 6 and 7%, between 7 and 10%, including any range between.

In some embodiments, a moisture content within the composition of the invention is less than 5% w/w, less than 3% w/w, less than 2% w/w, less than 1% w/w, less than 0.5% w/w, less than 0.3% w/w, less than 0.1% w/w, including any range therebetween.

In some embodiments, the composition of the invention comprises wood chips, the compost, the cured PFA, flour and optionally lignan. Non-limiting detailed examples of compositions suitable for manufacturing of any of the articles described herein, are listed in the Examples section. One of ordinary skills in the art will appreciate, that the exact ratios between the components of the composition or article of the invention may vary, and is predetermined by the desired degradation time of the of the composition or article.

In some embodiments, the composition of the invention comprises residual amounts of the catalyst. In some embodiments, the catalyst comprises an organic acid, an inorganic acid and/or a salt thereof (such as phosphoric acid, sulfuric acid, para-toluene sulfonic acid). In some embodiments, the composition comprises residual amounts of a solvent, a polymerization catalyst, an inorganic salt, or a combination thereof In some embodiments, the composition of the invention is substantially devoid of an organic solvent (such as chlorinated solvent, aromatic solvent, a hydrocarbon, a phenol-based solvent, or a combination thereof).

In some embodiments, the pesticide comprises mold, fungus, and/or yeast inhibitor. In one embodiment, the fungicide is potassium sorbate. In one embodiment, the fungicide is calcium sorbate. In one embodiment, the fungicide is sorbic acid. In one embodiment, the fungicide is Natamycin. In one embodiment, the fungicide is calcium Acetate. In one embodiment, the fungicide is sodium propionate. In one embodiment, the fungicide is potassium propionate. In one embodiment, the fungicide is calcium propionate. In one embodiment, the fungicide is propionic acid. In one embodiment, the fungicide is sodium diacetate.

In another embodiment, the w/w concentration of the fungicide within the composition is between 0.01 and 5%, between 0.01 and 0.1%, between 0.1 and 0.5%, between 0.5 and 1%, between 1 and 2%, between 2 and 5%, including any range between.

In some embodiments, the composition of the invention further comprises mucilage. In one embodiment, mucilage is a thick mixture of polar glycoprotein and an exopolysaccharide produced by a plant or a microorganism.

In some embodiments, mucilage is derived from Aloe vera. In another embodiment, mucilage is derived from Basella alba (Malabar spinach). In another embodiment, mucilage is derived from cactus. In another embodiment, mucilage is derived from Chondrus crispus (Irish moss). In another embodiment, mucilage is derived from Dioscorea opposita (nagaimo, Chinese yam). In another embodiment, mucilage is derived from Drosera (sundews). In another embodiment, mucilage is derived from Drosophyllum lusitanicum. In another embodiment, mucilage is derived from fenugreek. In another embodiment, mucilage is derived from flax seeds. In another embodiment, mucilage is derived from kelp. In another embodiment, mucilage is derived from liquorice root. In another embodiment, mucilage is derived from marshmallow. In another embodiment, mucilage is derived from mallow. In another embodiment, mucilage is derived from mullein. In another embodiment, mucilage is derived from okra. In another embodiment, mucilage is derived from parthenium. In another embodiment, mucilage is derived from Pinguicula (butterwort). In another embodiment, mucilage is derived from Psyllium seed husks. In another embodiment, mucilage is derived from Salvia hispanica (chia) seed. In another embodiment, mucilage is derived from Ulmus rubra bark (slippery elm).

In one embodiment, mucilage is Trigonella foenum-graecum mucilage. In another embodiment, the w/w concentration of the mucilage within the composition is between 0.01 and 5%, between 0.01 and 0.1%, between 0.1 and 0.5%, between 0.5 and 1%, between 1 and 2%, between 2 and 5%, including any range between.

In another embodiment, the composition as described herein comprises both sawdust and compost. In another embodiment, the weight (w:w) ratio between sawdust and compost is 4:1 to 1:2. In another embodiment, the weight (w:w) ratio between sawdust and compost is 3:1 to 1:1. In another embodiment, the weight (w:w) ratio between sawdust and compost is 2:1 to 1:1. In another embodiment, the weight (w:w) ratio between sawdust and compost is 2:1±30%. In another embodiment, the weight (w:w) ratio between sawdust and compost is 2:1±20%. In another embodiment, the weight (w:w) ratio between sawdust and compost is 2:1±10%. In another embodiment, the weight (w:w) ratio between sawdust and compost is 1:1±30%. In another embodiment, the weight (w:w) ratio between sawdust and compost is 1:1±20%. In another embodiment, the weight (w:w) ratio between sawdust and compost is 1:1±10%.

In another embodiment, the composition as described herein comprises both soil and compost. In another embodiment, the weight (w:w) ratio between soil and compost ranges from 4:1 to 1:2. In another embodiment, the weight (w:w) ratio between soil and compost is 3:1 to 1:1. In another embodiment, the weight (w:w) ratio between soil and compost ranges from 2:1 to 1:1. In another embodiment, the weight (w:w) ratio between soil and compost is 2:1±30%. In another embodiment, the weight (w:w) ratio between soil and compost is 2:1±20%. In another embodiment, the weight (w:w) ratio between soil and compost is 2:1±10%. In another embodiment, the weight (w:w) ratio between soil and compost is 1:1±30%. In another embodiment, the weight (w:w) ratio between soil and compost is 1:1±20%. In another embodiment, the weight (w:w) ratio between soil and compost is 1:1±10%. In another embodiment, the weight (w:w) ratio between soil and compost is 1:2±30%. In another embodiment, the weight (w:w) ratio between soil and compost is 1:2±20%. In another embodiment, the weight (w:w) ratio between soil and compost is 1:2±10%.

In some embodiments, the composition is a solid at a temperature less than 200° C., less than 150° C., less than 100° C., less than 70° C., less than 50° C., less than 30° C., less than 20° C., less than 10° C. including any range therebetween.

In some embodiments, the composition is characterized by elasticity sufficient, so as to retain its structural and/or functional properties during the automatic planting process. In some embodiments, the composition is characterized by elasticity sufficient to provide a support to a planted plant.

In some embodiments, the composition of the invention is gas permeable. In some embodiments, the composition of the invention is characterized by any of water vapor permeability, atmospheric gas permeability or both. In some embodiments, the composition of the invention is characterized by water vapor permeability and/or by atmospheric gas permeability, sufficient for supporting growth of a plant (cultivated plant such as an annual plant and/or a perennial plant or tree). In some embodiments, the composition of the invention is characterized by liquid permeability. In some embodiments, the composition of the invention is characterized by water permeability. In some embodiments, the water permeability is sufficient for supporting growth of a plant (e.g. facilitates bidirectional water and/or plant nutrients permeation through a composition layer, such as a wall of an article, as described herein). In some embodiments, the composition of the invention is characterized by swellability. In some embodiments, the composition of the invention is swellable upon contact with a liquid, such as water.

In some embodiments, the composition of the invention is stable (e.g. substantially retains its shape, geometrical form and is substantially devoid of structural defects or cracks, disintegration) when exposed to greenhouse conditions and/or to irrigation, for a time period of at least 6 months, at least 5 months, at least 4 months, at least 3 months, at least 2 months, at least 1 month, at least 3 weeks including any range between.

In some embodiments, the composition and/or article of the invention is degradable (e.g. via biodegradation and/or bioerosion) upon contact thereof with soil or rhizosphere. One of ordinary skills in the art will appreciate, that “soil” refers to an open field soil optionally comprising soil microbiome and various chemically active molecules, such as enzymes, etc. capable of inducing or enhancing degradation of the composition and/or article of the invention.

As used herein, the term “soil microbiome” refers to microorganisms living in a particular environment, including in the soil surrounding and/or interacting with the root of a plant. Optionally, the term “soil microbiome” refers to microorganisms located in the rhizosphere. Microorganism comprises bacteria, archaea, fungi, or a combination thereof.

In some embodiments, the term “biodegradable” describes a composition or article which can decompose under environmental condition(s) into breakdown products. Such environmental conditions include, for example, exposure to open field cultivation conditions such as soil microbiome, rhizosphere, temperature of between 0 and 50° C., UV radiation, irrigation, hydrolysis (decomposition via hydrolytic cleavage), enzymatic catalysis (enzymatic degradation), and mechanical interactions. This term typically refers to composition/article, which is capable of decomposition under these conditions, such that at least 50 weight percent of the composition/article decomposes within a time period shorter than two years.

In some embodiments, the term “biodegradable” as used in the context of embodiments of the invention, also encompasses the term “bioerodible”, which describes a composition/article which decomposes under environmental conditions into smaller fractions, thus substantially losing its structure and/or mechanical properties. In some embodiments, the term “bioerosion” refers to erosion of the composition/article initiated by microorganisms, and resulting in at least partial degradation of the composition/article.

In some embodiments, the composition and/or article of the invention is characterized by a gradual or sustained degradation profile, as opposed to a burst degradation profile. The terms sustained degradation and burst degradation are well-known in the art. Exemplary degradation profiles of the articles of the invention are described in the Examples section. In some embodiments, degradation of the composition and/or article of the invention is induced by a trigger, such as soil and water. In some embodiments, the trigger comprises any one of electron donating specie (a reducing agent), pH (e.g. between 5 and 10), a metal chelator, and irrigation or any combination thereof. In some embodiments, the trigger is or comprises open field conditions, such as a growing plant, soil and/or area under cultivation, soil microbiome or a combination thereof.

In some embodiments, the composition of the invention further comprises at most 10%, at most 8%, at most 5%, at most 3%, at most 1% w/w of a biopolymer (e.g. a hydrophobic polymer), including any range between. In some embodiments, the hydrophobic polymer is selected form polybutylene adipate terephthalate, and a starch derivative (e.g. modified starch, alkylated starch, carboxyalkylated starch, etc.) including any derivative or combination thereof. In some embodiments, the biopolymer (e.g. the hydrophobic polymer) is or comprises a biodegradable starch-based polymer such as Mater-Bi (Novamont). In some embodiments, the composition of the invention further comprises between 3 and 10%, between 3 and 5%, between 7 and 10% by weight of Mater-Bi, including any range between.

In some embodiments, the composition comprising between 3 and 10% w/w of the hydrophobic polymer (e.g. Mater-B) is characterized by enhanced durability and prolonged degradation in soil, as compared to a similar composition being devoid of the hydrophobic polymer. In some embodiments, the composition comprising between 3 and 10% w/w of the hydrophobic polymer (e.g. Mater-B) is characterized by prolonged degradation time in soil, wherein prolonged is by at least 50%, at least 100%, at least 200%, at least 300%, at least 400%, at least 500% including any range between, as compared to a similar composition being devoid of the hydrophobic polymer.

In some embodiments, the composition comprising at most 10% w/w of the hydrophobic polymer (e.g. Mater-B) is characterized by surface hydrophobicity.

In some embodiments, the composition comprising at most 10% w/w of the hydrophobic polymer (e.g. Mater-B) is substantially water impermeable.

In some embodiments, the composition of the invention has an average material density between 0.4 and 1 g/mL, between 0.4 and 0.6 g/mL, between 0.6 and 0.7 g/mL, between 0.7 and 0.8 g/mL, between 0.8 and 0.9 g/mL, between 0.9 and 1 g/mL, between 1 and 1.2 g/mL, including any range therebetween. In some embodiments, the composition has an average material density of: 0.8 (±0.4) g/mL.

In some embodiments, the composition of the invention is in a form of an article, as described hereinbelow.

### Article

The invention is particularly useful for articles or containers used in agriculture and home gardening, such as plant pots, plug trays, and any containers or receptacles of similar use. In another aspect of the invention, there is provided an article comprising the composition of the invention. In some embodiments, the article is a container. In some embodiments, the article is a plant article. In some embodiments, the article is a planting container.

In some embodiments, the article of the invention is stable (e.g. substantially retains its shape, geometrical form and is substantially devoid of structural defects or cracks, disintegration) when exposed to greenhouse conditions and/or to irrigation, for a time period of at least 10 months, at least 6 months, at least 5 months, at least 4 months, at least 3 months, at least 2 months, at least 1 month, at least 3 weeks including any range between.

In some embodiments, the article of the invention is stable when exposed to greenhouse conditions for a period ranging between 2 weeks and 10 months (m), between 2 w and 10 m, between 2 w and 6 w, between 6 w and 2 m, between 2 m and 5 m, between 5 m and 7 m, between 7m and 10 m, including any range between. The exact stability period is predetermined by the specific greenhouse cultivation time required for the plant.

In some embodiments, the term “stable” refers to the capability of the article to retain at least 80%, at least 90%, at least 95%, at least 99% of the geometrical shape and/or mechanical properties thereof under greenhouse conditions. In some embodiments, the stable article of the invention is substantially devoid of openings, cracks, or other structural defects upon exposure to greenhouse conditions for a time period described hereinabove. In some embodiments, the article is stable when it substantially retains its mechanical stability, so as to be suitable for subsequent planting in the open field, e.g. via an automated planting process.

In some embodiments, at least 70%, at least 80%, at least 85%, at least 90%, at least 95%, at least 97%, at least 99% of the articles of the invention, including any range between, are devoid of structural defects (e.g. cracks) upon exposure thereof to greenhouse condition for a time period ranging between 2 weeks and 10 months (m), between 2 w and 10 m, between 2 w and 6 w, between 6 w and 2 m, between 2 m and 5 m, between 5 m and 7 m, between 7m and 10 m, including any range between.

In some embodiments, the stable article of the invention refers to a plant container comprising a cultured plant, wherein the article is configured to substantially retain its function as a container. In some embodiments, the stable article of the invention, such as a plant container is configured to provide any of: (i) enclosing at least 90%, at least 93%, at least 95%, at least 97%, at least 99%, at least 99.9% of the plant roots, including any range between; (ii) providing an efficient barrier between the plant root and the ambient (e.g. ambient atmosphere) sufficient for preventing damage to the plant root, wherein damage refers to a mechanical damage (e.g. during transplantation) and/or to a damage induced by a pest. In some embodiments, the article is stable when it substantially (e.g. at least 60%, at least 70%, at least 80%, at least 90%, including any range between) retains its mechanical stability as determined by the Punch test.

In some embodiments, the article is biocompatible or bioerodible. In some embodiments, the article is at least partially degradable or biodegradable. In some embodiments, the article is at least partially erodible or bioerodible.

In some embodiments, the mechanical properties (e.g. strength and/or elasticity) of the article are reduced upon contact with soil. Without being bound to any theory it is postulated that biodegradation is induced by degradation of the organic matter such as the biopolymer (e.g. flour) and the organic component (e.g. wood and/or compost). After degradation of the organic matter, the article loses its structural intactness (e.g. shape or geometric form), thus resulting in a substantial degradation of the article. Without being bound to any theory it is postulated that an article being devoid of the biopolymer (e.g. flour) has a reduced biodegradability. In some embodiments, the article being devoid of the biopolymer (e.g. flour).

In some embodiments, at least 50%, at least 60%, at least 65%, at least 70%, at least 75%, at least 80%, at least 85%, at least 90%, at least 95% w/w of the article is biodegradable. In some embodiments, the biopolymer enhances biodegradability of the composition or article. In some embodiments, the article gradually loses it structural intactness upon contact with soil and/or water within a time period of between 2 and 15 weeks (w), between 2 and 4 w, between 4 and 6 w, between 8 and 10 w, between 10 and 15 w, between 9 and 12 w, between 12 and 15 w, including any range therebetween.

In some embodiments, the article of the invention is characterized by gradual or sustained degradation profile. In some embodiments, the article of the invention is characterized by a degradation profile adopted for cultivation of annual plants and/or perennial plants. In some embodiments, the article of the invention is configured to support growth of a young plant in a soil, thus preventing mechanical or biological damage (e.g. by a pest) to the plant roots on and post planting; and to facilitate plant roots growth (or breakthrough) through a wall of the article.

In some embodiments, the article of the invention is characterized by a predefined degradation time. In some embodiments, the degradation time is sufficient for so supporting plant growth and acclimatization upon transplanting thereof into the soil. One skilled in the art will appreciate, that various plant species (such as annual, perennial plants, ornamental plant and/or trees) require different acclimatization times, accordingly the degradation time of the article is predetermined by the acclimatization time of the specific plant species. In some embodiments, the degradation time of the article of the invention can by modified by controlling the chemical composition of the article (e.g. concertation of the cured polymer, cross-linking degree, ratio between the catalyst and the curable resin in the mixture, concentration and ratios between flour and compost, and optionally the ratio between the wood residue and fluor and/or compost).

In some embodiments, at least 50%, at least 60%, at least 65%, at least 70%, at least 75%, at least 80%, of the geometrical configuration or shape of the article is retained for a time period ranging between 2 and 15 weeks (w), between 2 and 4 w, between 4 and 6 w, between 8 and 10 w, between 10 and 15 w, between 9 and 12 w, between 12 and 15 w, including any range therebetween, upon contacting thereof with soil.

In some embodiments, the article of the invention refers to a plant container comprising a cultured plant, wherein the article comprising a cultured plant is configured to substantially retain its function as a container upon contacting thereof (e.g. by transplanting) with the soil, for a time period sufficient for acclimatization of the plant within the soil (e.g. between 2 and 15 weeks, as describe hereinabove). In some embodiments, the plant container upon contacting thereof with the soil is configured to provide at least one of: (i) enclosing at least 50%, at least 60%, at least 70%, at least 80%, at least 85%, at least 90%, at least 95% of the plant roots, including any range between; (ii) providing an efficient barrier between the plant root and the soil environment sufficient for preventing damage to the plant root, wherein damage refers to a mechanical damage (e.g. during transplantation) and/or to a damage induced by a pest.

In some embodiments, the article of the invention is substantially devoid of phytotoxicity.

In some embodiments, the article of the invention is configured to support plant growth, such as under greenhouse conditions and/or under cultivation condition, such as an open field cultivation. In some embodiments, the article of the invention is characterized by any of gas permeability, water permeability, and/or permeability to plant nutrients sufficient for supporting growth of a plant (cultivated plant such as an annual plant and/or a perennial plant or tree). The exact permeability values will depend on the specific needs of the cultivated plant. In some embodiments, the article of the invention comprises at least one permeable wall, wherein the permeable wall is characterized by gas permeability, water permeability, and/or permeability to plant nutrients sufficient for supporting growth of a plant. In some embodiments, the permeable wall facilitates bidirectional water and/or plant nutrients permeation therethrough in an amount and/or rate sufficient for supporting growth of a plant.

In some embodiments, the article of the invention is characterized by swellability, e.g. is swellable upon contact with a liquid, such as water.

In a further aspect of the invention, the container or article of the invention may be coated or treated with a bio-degradable coating comprising polylactic acid (PLA), or any biodegradable polymer known in the art. In some embodiments, a coating that may be used, as described in the PCT application PCT/IL2011/000739.

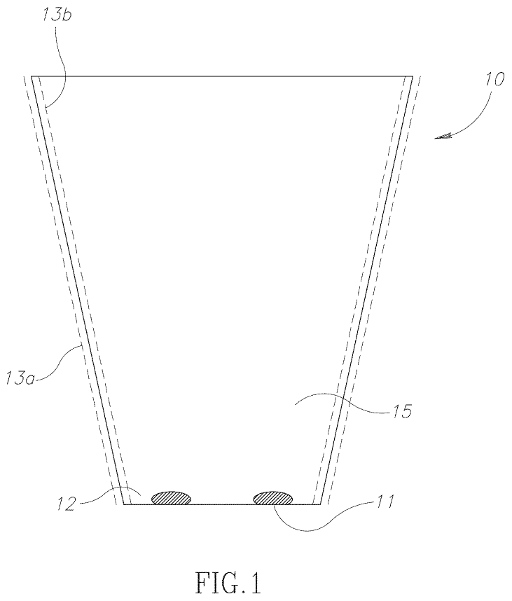

Reference is now made to FIG. 1 which schematically illustrates a plant pot according to embodiments of the invention. A (10) may include a body (15) made of an organic waste mixture according to embodiments of the invention, for example, any of the mixtures described in the Examples.

A typical plant pot (10) includes drainage holes (11) in its bottom part (12). According to one embodiment the outer walls and/or inner walls of the body (15) of the plant pot (10) may be coated (coating 13a and 13b correspondingly), by spraying or any other suitable method of coating. The coating (13a and 13b) may serve as a sealant to prevent early degradation of the organic mixture composing the pot.

Plant pots may be manufactured in assorted sizes, for example, 5.5, 12 and 18 cm diameter, and of 3, 4, 5, 6, 7, 8 and 9 L.

In some embodiments, a pot as described herein comprises the composition of the invention and optionally a coating layer. In some embodiments, a pot as described herein consists or comprises the composition, a coating layer, and soil/compost as planting bedding. In some embodiments, a pot as described herein consists or comprises the composition, a coating layer, soil/compost, and a plant.

In some embodiments, an uncoated pot average weight is: 75.0±8.0 g. In some embodiments, an uncoated pot average weight is: 75.0±6.0 g. In some embodiments, an uncoated pot average weight is: 75.0±4.0 g. In some embodiments, an uncoated pot average weight is: 75.0±3.0 g. In another embodiment, the phrase “uncoated pot” is uncoated standard 12 cm pot. In another embodiment, one of skill in the art can readily adapt the physical properties and measures to bigger or smaller pots.

In some embodiments, the article (e.g. plant pot) of the invention is characterized by an enhanced strength as compared to any available plant pots. In some embodiments, the article (e.g. plant pot) of the invention is characterized by an enhanced strength, as compared to an article having an analogous composition and being devoid of the cured thermoset polymer. In some embodiments, the cured polymer increased mechanical strength of the article. In some embodiments, the enhanced strength of the article facilitates manufacturing of an article with a decreased wall thickness. Thus, the article comprising the composition of the invention may have a thinner wall (e.g. body and or base) without impairing the mechanical strength and/or elasticity of the article.

In some embodiments the cross-section of top portion of the article is between Band 15 cm, between 10 and 13, between 10 and 15 cm, including any range between. In some embodiments the cross-section of bottom portion of the article is between 3and 8 cm, between 3 and 5, between 5 and 7 cm, between 7 and 10 cm, including any range between.

In some embodiments, the article of the invention has a body wall thickness of less than 0.2 cm, less than 0.19 cm, less than 0.18 cm, less than 0.17 cm, less than 0.16 cm, less than 0.15 cm, less than 0.13 cm, less than 0.11 cm, including any range between.

In some embodiments, the article as described herein, has a sufficient mechanical strength so as to support a plant growth. In some embodiments, the article as described herein, has a sufficient mechanical strength to facilitate automated planting.

In some embodiments, the article of the invention is particularly useful for articles or containers used in agriculture and home gardening, such as plant pots, plug trays, and any containers or receptacles of similar use including any combination thereof. In some embodiments, the article of the invention is a biodegradable and/or bioerodible article, such as planting container, a plant pots, a plant tray or any biodegradable and/or bioerodible containers or receptacles of similar use. In some embodiments, the article of the invention is shaped as food-ware.

In one exemplary embodiment, the thickness of an uncoated pot is as follows: upper rim 0.4±0.1 cm; body 0.1 to 0.15 cm; base 0.4 to 0.8 cm. In one exemplary embodiment, the thickness of an uncoated pot is as follows: upper rim 0.4±0.1 cm; body 0.1 to 0.15 cm; base 0.4 to 0.5 cm. In one exemplary embodiment, the thickness of an uncoated pot is as follows: upper rim 0.4±0.1 cm; body 0.1 to 0.15 cm; base 0.5 to 0.7 cm.

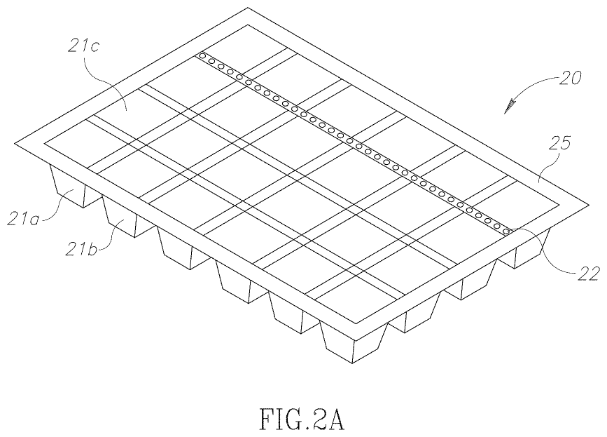

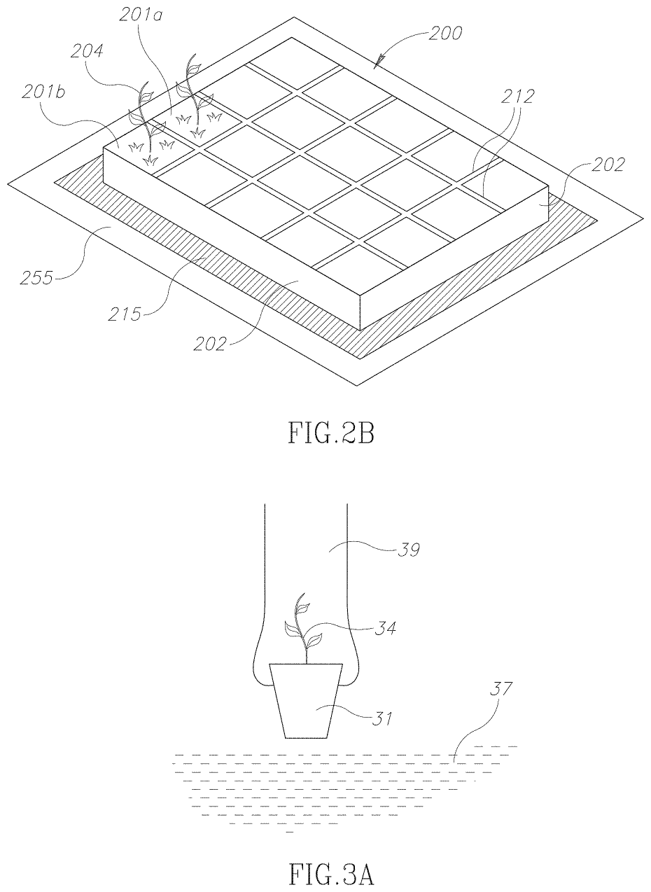

In yet a further aspect, the present invention provides a biodegradable tray for seedlings or young plants. FIG. 2A schematically illustrates a biodegradable tray according to one embodiment of the invention. The tray (20) is made of rows (and columns) of cells (21a, 21b, 21c, etc.) attached to each other or held together by a framework (25) to provide a matrix of cells. The cells (21a, 21b, 21c) are made of a biodegradable material, for example, the mixtures exemplified herein. According to some embodiments both the cells (21a, 21b, 21c) and the framework (25) are made of biodegradable material.

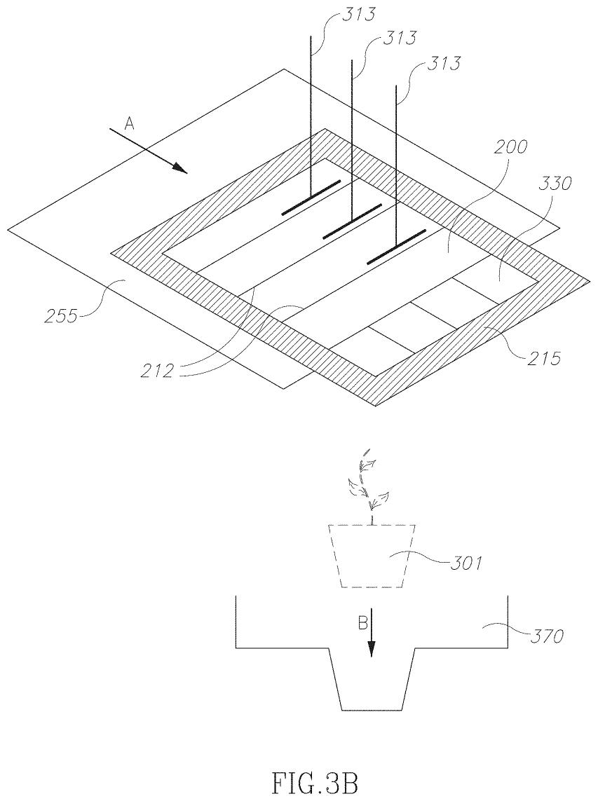

According to one embodiment the cells (21a, 21b, 21c) are cone or frustoconical shaped. This shape of cells may be advantageous while planting a plant in its cell, as will be further exemplified with reference to FIG. 3A.

Thus, individual cells or the whole tray or parts of the tray (20) which may contain seedling plugs may be planted directly in soil. The planted tray or parts of tray will eventually disintegrate in the soil leaving the seedling to flourish.

A tray according to embodiments of the invention may further be fully or partially coated as described in PCT/IL2011/000739 to enable “scheduled” disintegration of the biodegradable tray.

A planting tray according to another embodiment of the invention is described in FIG. 2B.

A tray (200) includes walls (202) and partitions (212) made of biodegradable material, e.g., the mixtures described herein. The tray (200) is placed within a frame construction (215) such that the walls of the construction (215) surround the tray (200). The tray within the frame construction is placed on a cutting board (255), which is typically part of an automated planting machine.

Individual cells (201a and 201b) within the tray (200) are defined by partitions (212) and each cell may contain a plant (204). The partitions (212) may be cut before planting by a transplanting machine (as further described with reference to FIG. 3B) to obtain individual cells (201a and 201b) that may be planted as a single unit with their plant (204). After being planted in the ground the cell may be degraded in the soil, leaving the plant (204) to flourish.

Embodiments of the invention provide rigid planting receptacles. For example, pot (10) (FIG. 1) or any of cells (21a, 21b or 21c) or (201a and 201b) (FIGS. 2A and B) may be used as a rigid planting receptacle.

FIG. 3A schematically illustrates how a rigid biodegradable planting receptacle may be used to facilitate automated planting, according to an embodiment of the invention. Appropriate crops such as tomato or other vegetable seedlings may be planted, for example in a biodegradable tray resembling tray (20). The cells of the tray are typically rigid enough to be handled by a transplanting machine while protecting the roots of the seedlings planted in them from pressure related damage. Prior to planting in the field (37) cells (31) having seedlings (34) in them are detached from the tray and may thus be individually handled by an automated arm (39) of a transplanting machine (not shown) without imparting pressure from the automated arm (39) to the seedling (34) roots. The cell (31) has a typically conical or frustoconical shape which may assist in creating a pit in the soil while pushing the cell (31) into the soil during planting. The cell (31), which is made of biodegradable material, for example, from the mixtures exemplified herein, is directly planted in the soil of the field (37), and will eventually disintegrate in the soil, leaving the seedling (34) to grow in the field (37). A tray may be broken into cells and the cells may be lined up and planted by a suitable transplanting machine.

According to one embodiment detaching of individual cells from the tray may be affected by an automated system, adapted to a planting machine, thus reducing cost and time of planting. Such a method of automated planting, according to another embodiment of the invention, is schematically illustrated in FIG. 3B.

A tray such as tray (200) surrounded by a frame structure (215) is placed on a cutting board (255) of a transplanting machine. Knives (313) of the transplanting machine cut along partitions (212) of the tray (200) leaving half of the partition as a wall for one cell and the other half of the partition as a wall for the adjacent cell. Both longitudinal and transverse partitions are typically cut, for example, by turning the tray (200) or the set of knives (313) 90° for each cutting session, such that individual cells such as cell (310) may be formed after cutting.

Typically, the frame construction (215) and the cutting board (255) are made of stainless steel or other metal.

After cutting, each cell is encased by the biodegradable rigid material that constituted partitions (212). After individual cells are produced by the cutting knives (313) the construction (215) holding the tray (200) may be pushed in the direction of arrow A such that a row (330) of cells is left without a bottom or floor. The cell in this row (330) will thus fall in the direction of arrow B, into a planting device (370).

This method of planting ensures that plants are advantageously protected during planting.

According to some embodiments, the biodegradable receptacle with the seedlings/young plants may be watered before planting, aborting the need for watering the receiving soil, and thus avoiding the complications resulting from muddy soil. Furthermore, watering the seedlings/young plants before transplantation also prevents their dehydration during the process of transplantation.

Thus, according to embodiments of the invention a cell or other receptacle may be transplanted into the soil together with the seedling/young plant like one unit.

In a specific embodiment of this aspect of the invention, the biodegradable rigid receptacle for seedlings or young plants is prepared or made out of the mixture of the invention as described herein. Such biodegradable rigid receptacle for seedlings or young plants which may be made with the mixture of the invention is thus advantageous over current transplantation techniques for the following reasons, amongst others:

It is biodegradable, and therefore the seedling or young plant may be planted together with the receptacle without the need for transplantation. Being biodegradable, the receptacle decomposes at the site of implantation, contributing and enriching the nutrition of the soil surrounding the young plant exemplary release of phytonutrients is demonstrated in the Examples section.

### Mixture

In another aspect of the invention, there is provided an uncured composition (also referred to herein as “mixture) comprising at least one organic component of the invention, and a curable resin, wherein a particle size of the organic component is between 1 and 4 mm, and wherein a weight per weight (w/w) ratio of the organic component to the curable resin within the uncured composition is between 4:1 and 10:1. In some embodiments, the resin is as described herein.

As used herein, the term “curable” refers to a compound capable of undergoing curing (e.g. monomer, polymer and/or oligomer comprising a reactive group such as an unsaturated bond). In some embodiments, a curable compound is referred to a compound which hardens upon curing. In some embodiments, a curable resin is capable of forming cross-links upon curing, such as thermal curing, UV/visible light curing, or both. In some embodiments, the curable resin is a thermosetting polymer or a thermosetting resin.

In some embodiments, the curable resin comprises any of epoxy resin. In some embodiments, the curable resin comprises furfuryl alcohol resin (e.g. Biorez 141010).

In some embodiments, the mixture of the invention comprises at least one organic component (e.g. compost), a biopolymer (e.g. flour) and the curable resin, wherein a w/w ratio between the at least one organic component and the biopolymer within the mixture is between 2:1 and 1:2; wherein a w/w concentration of the curable resin within the mixture is at least 2%, or at least 4% including any range between.

In some embodiments, the mixture of the invention comprises (i) at least one organic component (e.g. compost) characterized by a particle size of between 1 and 4 mm including any range between; (ii) a biopolymer (e.g. flour) being optionally in a particulate form, and characterized by a particle size of at most 1 mm, at most 0.5 mm, at most 0.3 mm, at most 0.2 mm including any range between; and (iii) the curable resin, wherein a w/w ratio between the at least one organic component and the biopolymer within the mixture is between 2:1 and 1:2 including any range between; wherein a w/w concentration of the curable resin within the mixture is at least 2%, or at least 4% including any range between.

In some embodiments, the mixture of the invention comprises (i) an organic component selected from compost and at least one of wood chips, bark and saw dust, and wherein the organic component is characterized by a particle size of between 1 and 4 mm including any range between; (ii) at least one biopolymer (e.g. flour) being optionally in a particulate form, and characterized by a particle size of at most 1 mm, at most 0.5 mm, at most 0.3 mm, at most 0.2 mm including any range between; and (iii) the curable resin, wherein a w/w ratio between the organic component and the biopolymer within the mixture is between 5:1 and 2:1 including any range between; wherein a w/w concentration of the curable resin within the mixture is at least 2%, or at least 4% including any range between.

In some embodiments, the mixture further comprises a hardener (e.g. an organic or inorganic acid and/or a salt thereof) and the wetting agent (or emulsifying agent), wherein the wetting agent is as described herein.

In some embodiments, the organic component comprises a mixture of wood chips and saw dust and/or compost, wherein the ratios are as described herein.

In some embodiments, the curable resin (i.e. resin in a liquid form) is mixed with the catalyst (e.g. phosphoric acid or para-toluene sulfonic acid) and optionally with the wetting agent, so as to form a liquid mixture. In some embodiments, the solid ingredients (e.g. wood chips and compost, and optionally saw dust and/or lignin, and optionally flour) are added to the liquid mixture, thereby forming the mixture of the invention.

In some embodiments, the w/w ratio between flour and the organic component (e.g. wood chips and compost) in the mixture of the invention is between 1:10 and 1:3, between 1:10 and 1:8, between 1:8 and 1:6, between 1:6 and 1:5, between 1:5 and 1:4, between 1:4 and 1:3, including any range between.

In some embodiments, the mixture comprises the organic component and the curable resin, at a w/w ratio between 4:1 and 20:1, between 4:1 and 6:1, between 6:1 and 8:1, between 8:1 and 10:1, between 10:1 and 12:1, between 12:1 and 15:1, between 15:1 and 20:1, including any range between.

In some embodiments, the mixture is in a form of a dough-like composition that may be shaped or molded and cured (e.g. by pressure-molding, or thermal molding) into pots or other articles (such as food-ware). The cured articles are then optionally dried (possibly by heating). According to another embodiment the mixture is shaped into a pot by press forming or by thermoforming. Other methods may be used for preparing the plant pot body.

In some embodiments, the biopolymer (e.g. flour) provides sufficient shapeability or plasticity to the mixture. In some embodiments, the mixture of the invention comprising flour is characterized by sufficient plasticity so as to facilitate subsequent shaping or molding the article of the invention. In some embodiments, the biopolymer facilitates adhesion of the mixture components, so as to from a shapeable mixture. In some embodiments, the mixture comprising at least 2%, or at least 4% w/w of the curable resin is a shapeable mixture.

In some embodiments, the mixture has a consistency appropriate for shaping the article of the invention. In some embodiments, the curable resin provides adhesiveness to the plurality of particles of the organic waste component. In some embodiments, the curable resin adheres the plurality of particles of the organic waste component. In some embodiments, the organic component is wettable by the curable resin.

In some embodiments, the moisture content (i.e. water content) of the organic component as described herein is required for the formation of a shapeable mixture. In some embodiments, the moisture content of the organic waste predetermines a consistency of the mixture being appropriate for shaping the article of the invention. In some embodiments, the moisture enhances adhesiveness of the plurality of particles of the organic waste component. In some embodiments, the moisture enhances affinity of the organic component to the curable resin. In some embodiments, the moisture increases wettability of the organic component by the curable resin.

In some embodiment, the mixture of the invention comprises water. In some embodiment, the moisture content of the mixture of the invention is in a range between 8 and 20% w/w. In some embodiments, the moisture content of the mixture of the invention is between 8 and 20% w/w, between 8 and 10% w/w, between 10 and 12% w/w, between 12 and 15% w/w, between 15 and 20% w/w, including any range therebetween.

In some embodiments, the volume (v/v) ratio between water and the emulsifying agent ranges from 4:1 to 45:1, from 8:1 to 40:1, from10:1 to 35:1, from 15:1 to 30:1 including any range therebetween. In some embodiments, the volume (v:v) ratio between water and the emulsifying agent is 23:1±20%. In one embodiment, the emulsifying agent is glycerol.

In some embodiments, the mixture of the invention is flexible. In some embodiments, the mixture of the invention is shapeable, i.e., deformable (e.g., prior to a curing step, as disclosed herein). In some embodiments, the mixture of the invention is pliable. In some embodiments, the mixture of the invention is moldable. In some embodiments, the mixture of the invention is suitable for compression molding.

Manufacturing process

In another aspect, there is provided a process for manufacturing the article of the invention, comprising the steps of:
a. providing the mixture of the invention comprising the organic component, the curable resin and optionally the biopolymer, at a w/w ratio between 4:1 and 10:1, wherein a moisture content of the organic component is between 8 and 20% w/w, and wherein the mixture comprises a catalyst;
b. molding the mixture under suitable conditions, thereby obtaining the article.

In some embodiments, the mixture is prepared by providing the organic waste component, wherein the organic component is as described herein, and optionally adding water or an aqueous solution to the organic component so as to obtain a moisture content of the organic component or of the mixture being in a range between 8 and 20% w/w. In some embodiments, the moisture content of the organic component between 8 and 20% w/w, between 8 and 10% w/w, between 10 and 12% w/w, between 12 and 15% w/w, between 15 and 20% w/w, including any range therebetween. In some embodiments, the mixture with the moisture content of greater than 20% results in unstable pots. In some embodiments, the moisture content below 8% results in a non-homogenous or unshapeable mixture. In some embodiments, the moisture content below 8% is insufficient for manufacturing an article.

In some embodiments, the organic component is further mixed with an acid or with the wetting agent, wherein the wetting agent is as described herein.

In some embodiments, the organic component comprises a mixture of wood chips and saw dust and/or compost, wherein the ratios are as described herein.

In some embodiments, the curable resin (i.e. resin in a liquid form) is mixed with the catalyst (e.g. phosphoric acid or para-toluene sulfonic acid) and optionally with the wetting agent, so as to form a liquid mixture. In some embodiments, the solid ingredients (e.g. wood chips and compost, and optionally saw dust and/or lignin, and optionally flour) is added to the liquid mixture, thereby forming the mixture. In some embodiments, the curable resin is mixed with the organic component, the biopolymer and optionally with the wetting agent, following by addition of the catalyst, thus forming the mixture.

In some embodiments, the mixture comprises the organic component, the thermoset polymer, and the biopolymer such as flour. In some embodiments, the w/w ratio between flour and the organic component (e.g. wood chips and compost) is between 1:10 and 1:3, between 1:10 and 1:8, between 1:8 and 1:6, between 1:6 and 1:5, between 1:5 and 1:4, between 1:4 and 1:3, including any range between.

In some embodiments, the mixture comprises the organic component and the thermoset polymer, at a w/w ratio between 4:1 and 20:1, between 4:1 and 6:1, between 6:1 and 8:1, between 8:1 and 10:1, between 10:1 and 12:1, between 12:1 and 15:1, between 15:1 and 20:1, including any range between.

In another embodiment, the process of preparing the liquid mixture or the mixture is performed under constant mixing. In some embodiments, lukewarm water (20-30° C.) is used.

Water may be added to a mixture containing organic waste and curable resin to obtain a dough-like composition that may be shaped and cured (e.g. by pressure-molding, or thermal molding) into pots or other articles (such as food-ware). The cured articles are then optionally dried (possibly by heating). According to another embodiment the mixture is shaped into a pot by press forming or by thermoforming. Other methods may be used for preparing the plant pot body.

In some embodiments, the biopolymer (e.g. flour) provides sufficient shapeability or plasticity to the mixture. In some embodiments, the mixture of the invention comprising flour is characterized by sufficient plasticity so as to facilitate subsequent shaping or molding the article of the invention. In some embodiments, the biopolymer facilitates adhesion of the mixture components, so as to from a shapeable mixture.

In some embodiments, curable resin in contact with other ingredients of the mixture forms a shapeable mixture. In some embodiments, the mixture has a consistency appropriate for shaping the article of the invention. In some embodiments, the curable resin provides adhesiveness to the plurality of particles of the organic waste component. In some embodiments, the curable resin adheres the plurality of particles of the organic waste component. In some embodiments, the organic component is wettable by the curable resin. In some embodiments, the organic component has a sufficient affinity to the curable resin, so as being capable of binding or adhering thereto.

In some embodiments, the moisture content (i.e. water content) of the organic component as described herein is required for the formation of a shapeable mixture. In some embodiments, the moisture content of the organic waste predetermines a consistency of the mixture being appropriate for shaping the article of the invention. In some embodiments, the moisture enhances adhesiveness of the plurality of particles of the organic waste component. In some embodiments, the moisture enhances affinity of the organic component to the curable resin. In some embodiments, the moisture increases wettability of the organic component by the curable resin.

In some embodiments, the wetting agent is required for the formation of a shapeable mixture. In some embodiments, the wetting agent predetermines a consistency of the mixture being appropriate for shaping the article of the invention. In some embodiments, the wetting agent enhances adhesiveness of the plurality of particles of the organic waste component. In some embodiments, the wetting agent enhances affinity of the organic component to the curable resin. In some embodiments, the wetting agent adheres the plurality of particles. In some embodiments, the wetting agent increases wettability of the organic component by the curable resin.

In another embodiment, potassium sorb ate and/or calcium sorb ate are added to the mixture. In another embodiment, organic acid treated wood chips and/or sawdust are added to the lukewarm water, thermoset polymer (e.g. PFA), propylene glycol, and glycerol mixture. In another embodiment, mucilage is further added to the mixture. In another embodiment, each step of adding a material to the mixture is accompanied by mixing.

In another embodiment, ash or any source of cellulosic/lignocellulosic material is further added and mixed. In another embodiment, the 75% remaining flour is added and mixed. In another embodiment, compost is added and mixed. In another embodiment, soil/dirt mixture is added and mixed. In another embodiment, slow-release fertilizer (e.g. Osmocoat, potassium humate granular, etc.) is optionally added and mixed.

In another embodiment, dough was stored in a proofer to maintain moisture levels and to increase material temperature to 30-50° C.

In another embodiment, a mixture as described herein is used as a building material for in-situ degradable plant pots. In some embodiment, the mixture comprises water. In some embodiments, the volume (v:v) ratio between water and the emulsifier ranges from 4:1 to 45:1. In some embodiments, the volume (v:v) ratio between water and the emulsifier ranges from 8:1 to 40:1. In some embodiments, the volume (v:v) ratio between water and the emulsifier ranges from 10:1 to 35:1. In some embodiments, the volume (v:v) ratio between water and the emulsifier ranges from 15:1 to 30:1. In some embodiments, the volume (v:v) ratio between water and the emulsifier is 23:1±20%. In some embodiments, the volume (v:v) ratio between water and the emulsifier is 23:1±10%. In one embodiment, the emulsifier is glycerol.

In some embodiments, the volume (v:v) ratio between water and the thermoset polymer (the curable thermoset resin is in a liquid form at a room temperature) ranges from 4:1 to 45:1. In some embodiments, the volume (v:v) ratio between water and the thermoset polymer ranges from 8:1 to 40:1. In some embodiments, the volume (v:v) ratio between water and the thermoset polymer ranges from 10:1 to 35:1. In some embodiments, the volume (v:v) ratio between water and the thermoset polymer ranges from 10:1 to 20:1. In some embodiments, the volume (v:v) ratio between water and the thermoset polymer is 23:1±20%. In some embodiments, the volume (v:v) ratio between water and the thermoset polymer is 23:1±10%. In one embodiment, the thermoset polymer is PFA. In another embodiment, the method of manufacturing the plant pot as described herein optionally comprises pre-treatment of wood chips or sawdust by soaking in an organic acid solution. In some embodiments, steam is applied to the organic component so as to increase a moisture content thereof (e.g. so as to result in about 15% humidity).

In another embodiment, the Punch test strength of an exemplary uncoated pot of the invention is: upper portion/bottom portion/medial portion of the pot is 6.4/10.6/8.5 kg/cm²±30%, respectively. As used herein, the term “upper portion” refers to the top part of the plant pot, facing the ambient one skilled in the art will appreciate, that the term upper or top and term bottom are related to the predefined orientation (e.g. planting direction) of the pot. In another embodiment, the Punch test strength of uncoated pot is: top of pot/near bottom of pot/average is 6.4/10.6/8.5 kg/cm²±15%. In another embodiment, the Punch test strength of uncoated pot is: top of pot/near bottom of pot/average is 6.4/10.6/8.5 kg/cm²±10%. In another embodiment, the Punch test strength of uncoated pot is: top of pot/near bottom of pot/average is 6.4/10.6/8.5 kg/cm²±5%.

In some embodiments, the method comprises shaping the mixture, thereby forming the article. In some embodiments, the method comprises molding the mixture. In some embodiments, molding comprises compression molding. In some embodiments, compression molding compress applying a compression force to the mixture, wherein the compression force is less than 7, less than 6, less than 5 ton-force, including any range therebetween.

In some embodiments, compression molding compress applying a compression force to the composition within the mold, wherein the compression force is between 100 kg and 60 ton, between 100 and 110 kg, between 110 and 150 kg, between 150 and 200 kg, between 200 and 300 kg, between 300 and 500 kg, between 500 and 1000 kg, between 1 and 5 ton, between 5 and 10 ton, between 10 and 30 ton, between 30 and 50 ton, between 40 and 60 ton, including any range therebetween.

In some embodiments, compression molding comprises applying a compression force between 1 and 5 ton, between 1 and 2 ton, between 2 and 3 ton, between 3 and 4 ton between 4 and 5 ton, including any range between.

In some embodiments, molding comprises curing the thermoset polymer under suitable conditions, thereby obtaining a cured article. In some embodiments, suitable conditions comprise exposing the mixture to a thermal radiation, a UV/vis radiation or both. In some embodiments, suitable conditions comprise exposing the mixture to a temperature between 50 and 200° C.

In some embodiments, molding comprises curing the thermoset polymer by exposing the mixture to a temperature between 50 and 200° C., between 50 and 70° C., between 70 and 100° C., between 100 and 130° C., between 130 and 150° C., between 150 and 200° C., between 200 and 300° C., including any range therebetween.

In some embodiments, compression molding is performed by applying a compression force between 100 kg and 5 ton, and by exposing the mixture to a temperature between 50 and 250° C. thereby obtaining a shaped article.

In some embodiments, the manufacturing process further comprises exposing the molded or shaped article to a temperature between 100 and 250° C. for a time period between 10 min and 2 hours. In some embodiments, the molded or shaped article is exposed to a temperature between 100 and 250° C., between 100 and 150° C., between 150 and 170° C., between 170 and 200° C., between 200 and 210° C., between 210 and 230° C., between 230 and 250° C., including any range between for a time period between 10 min and 2 hours. In some embodiments, the molded or shaped article is exposed to a temperature between 180 and 250° C., for a period between 10 min and 2 hours, between 10 min and 30 min, between 30 min and 1 hour (h), 30 min and 50 min, 40 min and 1 hour (h), between 1 and 1.1 h, between 1 and 1.5 h, between 1.5 and 2 h including any range between. In some embodiments, the additional heating of the shaped article is for providing water impermeability to the article of the invention. In some embodiments, the additional heating of the shaped article is for reducing water permeability of the article of the invention.

In some embodiments, the molding step is performed under low pressure between 80 and 150 kg, between 80 and 90 kg, between 90 and 100 kg, between 100 and 105 kg, between 105 and 110 kg, between 110 and 150 kg, including any range between. In some embodiments, the molding step performed under low pressure and at a temperature as described herein results in the water impermeable article. In some embodiments, the water impermeable article retains at least 80%, at least 90%, at least 95%, at least 97%, at least 99% of its geometrical shape upon irrigation for at least 2 months, at least 3 months, at least 4 months, at least 5 months, including any range between. Without being bound to any theory, it is postulated, that the article formed by low compression retains surface hydrophobicity of cellulose, thus resulting in a substantially water impermeable article. In some embodiments, substantially is at least 80%, at least 85%, at least 90%, at least 91%, at least 92%, at least 93%, at least 94%, at least 95%, at least 97%, at least 98%, at least 99%, including any range between.

In another embodiment, the mixture is injected and molded into its final shape. In another embodiment, the mold is either opened at once, or pre-cooled and then opened; the pot is then removed from the base, and allowed to further cool to room temperature.

In another embodiment, the pots are further coated as described in co-pending PCT application PCT/IL2011/000739.

In another aspect the present invention provides a bio-degradable container. In another aspect the present invention provides that the phrase “bio-degradable container” is synonymous with the terms “bio-degradable article” or “bio-degradable pot”. Articles made of the mixtures according to embodiments of the invention may be made as rigid as required, depending on parameters such as the specific ratios of dry (e.g., organic waste and adhesive components) and wet materials (e.g., water) used in the mixture, the particle size of the dry material (larger particles imparting better solidity), the temperature during pressing and other parameters.

In another embodiment, the term “mixture” according to the invention includes the terms “suspension” or “dispersion”. In another embodiment, a mixture as described herein is homogeneous. In another embodiment, a mixture as described herein is obtained by vigorous mixing in an aqueous solution such as water.

In another embodiment, “water” is deionized water. In another embodiment, “water” is lukewarm water. In another embodiment, the term “comprise” includes the term “consist” or is replaceable by the term “consist”. In another embodiment, the term “about” includes ±10% of the indicated value. In another embodiment, the term “about” includes ±7.5% of the indicated value. In another embodiment, the term “about” includes ±5% of the indicated value.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method, or structure may include additional ingredients, steps and/or parts, but only if the additional ingredients, steps and/or parts do not materially alter the basic and novel characteristics of the claimed composition, method, or structure.

In some embodiments, substantially comprises at least 50%, at least 60%, at least 70%, at least 75%, at least 80%, at least 85%, at least 90%, at least 95%, at least 97%, at least 99%, by weight of the cosmetic active ingredient. In some embodiments, substantially comprises at least 50%, at least 60%, at least 70%, at least 75%, at least 80%, at least 85%, at least 90%, at least 95%, at least 97%, at least 99%, including any range between.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical, and medical arts.

As used herein, the term “increasing” or “enhancing” including any grammatical form thereof, comprises enhancement of at least at least 50%, at least 100%, at least 200%, at least 300%, at least 400%, at least 500%, at least 1000%, at least 10.000% including any range between.

As used herein, the term “decreasing” or “reducing” including any grammatical form thereof, comprises reduction of at least 10%, at least 20%, at least 30%, at least 50%, at least 60%, at least 65%, at least 70%, at least 75%, at least 80%, at least 85%, at least 90%, at least 95%, at least 100%, at least 200%, at least 500%% including any range between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments unless the embodiment is inoperative without those elements.

Various embodiments and aspects of the present invention as delineated hereinabove and as claimed in the claims section below find experimental support in the following examples.

The following Examples are representative of techniques employed by the inventors in carrying out aspects of the present invention. It should be appreciated that while these techniques are exemplary of embodiments for the practice of the invention, those of skill in the art, in light of the present disclosure, will recognize that numerous modifications can be made without departing from the intended scope of the invention.

### EXAMPLES

### Example 1

The inventors successfully manufactured bioerodible planting articles by utilizing the mixtures and methods described hereinbelow.

Resin: Biorez 141010 (aqueous solution containing about 80% w/w of PFA and about 1.5% of a catalyst) was purchased from Trans Furans Chemicals.

Mixture I
80-300 g Resin and 4-10% of a hardener (H₃PO₄)
180 g wheat flour
600 g wood chips
360 g compost
70 g glycerol and 35 g PG (optional)

Mixture II
25-100 g Resin and 4-10% of a hardener (H₃PO₄)
180 g wheat flour
180 g wood chips (10% water content)
60 g wood dust (10% water content)
240 g compost

Mixture III
25-100 g Resin and 4-10% of a hardener (H₃PO₄)
180 g wheat flour
90 g wood chips (10% water content)
90 g wood dust (10% water content)
300 g compost (10% water content)

Mixture IV
25-100 g Resin and 4-10% of a hardener (H₃PO₄)
180 g wheat flour
300 g wood chips (10% water content)
180 g compost (10% water content)
20 g lignin

Mixture V
50 g Resin and 10-20% of a hardener (H₃PO₄)
50 g glycerin
300 g wood chips (10% water content)

Mixtures I to IV were shapeable and resulted in stable biodegradable pots. Mixture V was unshapeable, accordingly no pots could be formed.

The process of making the mixture included mixing the organic materials (wood chips, compost and/or saw dust); and adding the biopolymer (flour or starch), thereby forming a dry mix. In some embodiments, water was then added to the dry mix so as to result in the desired moisture content of the dry mix. In some embodiments, steam may be applied to the dry mix or to the organic material, so as to result in the desired moisture content of the organic material.

The materials were added under constant mixing (PG, Resin, catalyst, and glycerol). These materials were adequately mixed until a homogenous mixture was obtained.

Then, the following agents may be added: potassium sorbate, mucilage (in this recipe fenugreek was chosen; but mucilage material can include but is not limited to: Aloe vera; Basella alba (Malabar spinach); cactus; Chondrus crispus (Irish moss); Dioscorea opposita (nagaimo, Chinese yam); Drosera (sundews); Drosophyllum lusitanicum; fenugreek, flax seeds; kelp, liquorice root; marshmallow; mallow; mullein, okra; parthenium; pinguicula (butterwort); Psyllium seed husks; Salvia hispanica (chia) seed; Ulmus rubra bark (slippery elm)). The above materials are adequately mixed for <1 min, until mixture became homogenous.

Then, the following agents may optionally be added: cellulosic/lignocellulosic material (here, wood; can be nutshells, etc.); may include wood ash: the equivalent of 2.5-4 g per pot, starch (wheat starch; can include, but not limited to: potato, rice, corn starches), compost and/or humus; may include addition of “compost tea”: 1-3 mL per pot, soil/dirt mixture, optional addition at this stage may include any of a series of known fertilizers or of slow-release fertilizer compounds (e.g. Osmocoat, potassium humate granular, etc.)).

These materials are adequately mixed until mixture became adequately homogenous; dough stored in a proofer to maintain moisture levels and to increase material temperature to 30-50° C.

The pots may be created by press. The press process comprised of two or three separate parts: the base, or ‘male’ counterpart; the sheath, or ‘female’ counterpart; and the plunger. Alternately, the sheath and plunger were combined into one piece (the sheath-plunger).

The parts of the press may be pre-heated (base: 135° C., sheath: 150-170° C., plunger: 145-160° C., or sheath-plunger: 150-170° C.). Each of the parts was oiled with an emulsion of water and palm oil in a 40:60 ratio.

The temperature of mold pieces is increased to: base, 170-220° C.; sheath, 170-220° C.; plunger, 160-200° C., or sheath-plunger, 160-200° C.; the material is baked in this way for 0.5 to 20 minutes; alternatively the material is injected and was molded into its final shape. The mold may be closed or left partially opened, so as to facilitate pressure release. The mold is either opened at once, or pre-cooled and then opened; the pot is then removed from the base, and allowed to further cool to room temperature.

### Coating Process

Pre-coating spray or dip may be applied using water and/or water oil in 50:50 emulsion containing antibacterial/antifungal material, including but not limited to: methyl paraben, Trelin TC®, additional organic acids. The coating process may be conducted either by immersion in solution, thermo film-coating, or spray coating. Immersion entails 5 seconds to 10 minutes in a solvent containing a coating polymer dissolved therein. In some embodiments, the solvent comprises an organic solvent selected from ethyl acetate, methylene chloride, propylene chloride, dichloropropane, methyl chlorobenzene, chlorobenzene, butyl acetate, acetone, butanol). In some embodiments, the coating polymer comprises a biodegradable polymer. In some embodiments, the biodegradable polymer comprises Polybutylene adipate terephthalate and/or a starch-based polymer (Mater-Bi, Novamont).

### Example 2

Exemplary articles of the invention (e.g. plant pots) have been manufactured according to the method described in the Example 1. Subsequently, the articles were filled with a cultivation substrate and utilized for growing of various plants(such as annual weeds, or ornamental plants, and/or trees). The inventors tested stability and degradation of the exemplary articles of the invention in a greenhouse and in soil after transplantation. Some of the results are summarized in Tables 1 and 2 below.

TABLE 1
exemplary degradable planting articles

| | | | | Calculated | Calculated |
|---|---|---|---|---|---|
| | Preferable | | | degradation | degradation |
| | degradation | Preferable | | period in | period in |
| Proposed | period in | stability in | Exemplary | greenhouse | soil |
| use | soil | green house | mixture | [weeks] | [weeks] |
| Annual | 4-6 weeks | 4 weeks- | 7-10% resin | 4-6 | 6 |
| (ornamental | | 4 months | (relative to the | | |
| plants) | | | mixture) | | |
| | | | 3-5% hardener | | |
| | | | (relative to the | | |
| | | | resin) | | |
| | | | 550-650 g wood | | |
| | | | chips/saw dust | | |
| | | | 300-400 g | | |
| | | | compost | | |
| | | | 300-400 g flour | | |
| Annual | 2-3 weeks | 3 w-2 m | 4-5% resin | 3-8 | 4 |
| (crop | | | (relative to the | | |
| plants) | | | mixture) | | |
| | | | 3-5% hardener | | |
| | | | (relative to the | | |
| | | | resin) | | |
| | | | 550-650 g wood | | |
| | | | chips/saw dust | | |
| | | | 330-450 g | | |
| | | | compost | | |
| | | | 330-450 g flour | | |
| Perennial | 12-15 weeks | 4-9 m | 12-15% resin | 16 | 16 |
| (tress) | | | (relative to the | | |
| | | | total weight of | | |
| | | | the mixture) | | |
| | | | 3-5% hardener | | |
| | | | (relative to the | | |
| | | | resin) | | |
| | | | 600-750 g wood | | |
| | | | chips/saw dust | | |
| | | | 200-350 g | | |
| | | | compost | | |
| | | | 200-350 g flour | | |
| | | | 3-5% Matter-Bi | | |
| | | | (relative to the | | |
| | | | mixture) | | |

TABLE 2
exemplary compositions of the invention

| | | | | % emulsifier | |
|---|---|---|---|---|---|
| # | % Resin | % compost | % flour | (glycerin) | |
| Entry | [weight %] | [weight %] | [weight %] | [weight %] | Comments |
| 1 | 2.5-4 | 20-30 | 20-30 | 0.5-5 | moldable composition, |
| | | | | | stable pots. Soil |
| | | | | | degradation after |
| | | | | | about 4 weeks |
| 2 | 20-40 | 20-30 | 20-30 | 0-5 | moldable composition, |
| | | | | | stable pots. Non- |
| | | | | | degradable pots |
| 3 | 2-4 (~4) | 20-30 | 20-30 | 0 | moldable composition, |
| | | | | | cracked pots (in |
| | | | | | greenhouse) |
| 4 | less than 2 | 20-30 | 20-30 | 0-5 | non-moldable, crumbly |
| | | | | | composition |
| 5 | 2.5-4 | 35-60 | 35-60 | 0-5 | fast degradation |
| 6 | 7-15 | 20-30 | 20-30 | 0.5-5 | moldable composition, |
| | | | | | stable pots. Soil |
| | | | | | degradation after |
| | | | | | about 6-7 weeks |

Exemplary plant pots of the invention have been tested under greenhouse conditions, by planting young annual weeds into each pot and assessing (visually) the stability of the tested pots. The tested pots were substantially devoid of cracking (e.g. less than 5% of the tested pots) within the tested time period.

Furthermore, the inventors successfully increased stability (and prolonged degradation time) of the exemplary articles of the invention in soil by implementing a hydrophobic biodegradable biopolymer (Matter Bi) into the mixture of the invention (e.g. Entryl, Table 2). By adding 2-5% by weight of the hydrophobic biopolymer the resulting article was characterized by an increased (up to 4 times) stability under greenhouse conditions, and further by prolonged (up to 2 times) soil degradation time. The inventors assume, that by implementing up to 10% by weight of the hydrophobic biopolymer within the mixture of the invention, it is possible to obtain planting articles characterized by soil degradation period (e.g. almost complete degradation of the container) of about 9-10 months.

Additionally, the soil stability of the exemplary articles of the invention can be further increased by increasing the amount of hardener (e.g. about 10-30% by weight of the curable resin).

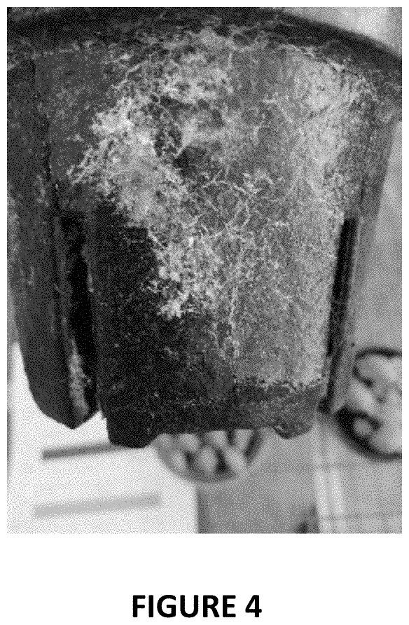

The degradation profile has been assessed via mineralization assay and/or visually. FIG. 4 represents a photograph of an exemplary plant pot after transplanting thereof into the soil. As shown in FIG. 4, the geometrical shape of the plant pot is substantially intact, thus providing protection to the plant roots from damage related to pests and/or mechanical stress. At the same time, the tested plant pot supports plant growth by facilitating root breakage and propagation through the side wall of the tested plant pot.

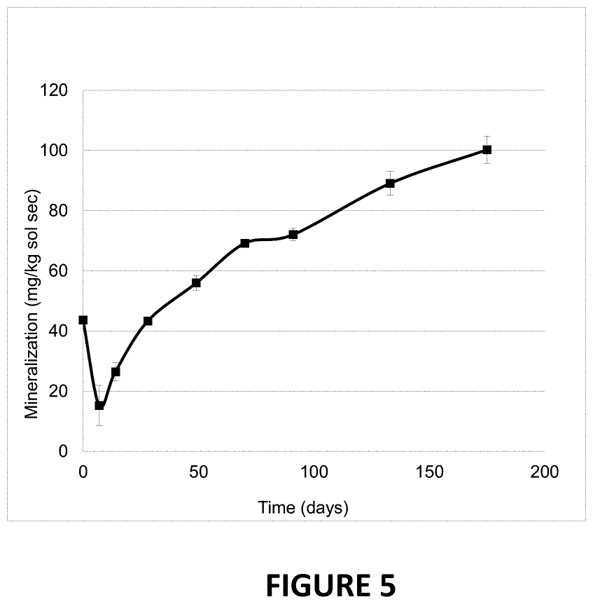

Furthermore, the degradation of exemplary plant pots of the invention has been assessed via mineralization assay, performed according to FD U44-163 standard. FIG. 5 represents nitrogen mineralization profile of an exemplary article of the invention. As shown in FIG. 5, the article of the invention gradually releases nitrogen species (e.g. nitrate salts, etc.) into the soil. Accordingly, the article of the invention can be further utilized as fertilizer, or as a carrier for any available plant nutrient agent or anti-pest agent.

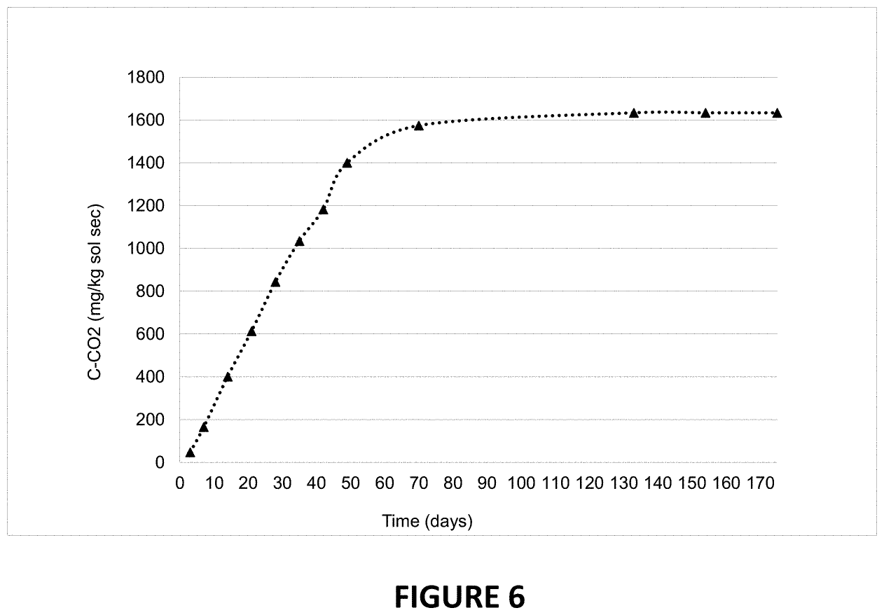

FIG. 6 represents carbon mineralization profile of an exemplary article of the invention, which may be also interpreted as the degradation profile of the article. As shown in FIG. 6, the article of the invention gradually decomposes, and after a time period ranging between 6 and 10 weeks undergoes an almost complete degradation, thus altering it's functionality as a container.

The inventors successfully utilized exemplary plant pots of the invention for cultivation of various annual and perennial plant. The plant pots did not reduce the growth of the tested plant species. Accordingly, it was postulated, that the articles of the invention are substantial non-phytotoxic.

Disclosed and described, it is to be understood that this invention is not limited to the particular examples, process steps, and materials disclosed herein as such process steps and materials may vary somewhat. It is also to be understood that the terminology used herein is used for the purpose of describing particular embodiments only and not intended to be limiting since the scope of the present invention will be limited only by the appended claims and equivalents thereof.

1. An article comprising an organic component, a biopolymer, and a cured thermoset polymer, wherein:
a particle size of said organic component is between 1 and 4 mm;
a weight per weight (w/w) ratio of said organic component to said thermoset polymer within said article is between 4:1 and 10:1; and
a w/w concentration of said cured thermoset polymer within the article of the invention is between 2 and 20%.

2. The article of claim 1, wherein said article further comprises up to 20% w/w of an emulsifying agent, optionally wherein said emulsifying agent is any one of propylene glycol, glycerin, PEG, ethylene glycol, silicone oil, an alcohol, or any combination thereof

3. (canceled)

4. The article of claim 1, wherein said thermoset polymer comprises polyfurfuryl alcohol (PFA), polyethyleneglycol, polyester, polyepoxide including any copolymer or any combination thereof.

5. (canceled)

6. The article of claim 1, wherein a moisture content within said article is less than 5% w/w.

7. The article of claim 1, wherein said organic component is selected from the group consisting: wood chips, soil, saw dust, compost, biomass, and ash; wherein said biopolymer is selected from the group consisting of starch, flour, modified starch, cellulose, carboxymethylcellulose, methylcellulose, nitrocellulose, chitosan, alginate, pectin, Xanthan gum, gelatin, or any combination thereof.

8. (canceled)

9. The article of claim 1, wherein said composition comprises wood chips, compost, cured PFA and flour.

10. The article of claim 1, wherein said article is in a form of a container, wherein said article comprises a wall being between 1.5 and 4 mm thick; optionally wherein said article is a planting article, wherein said planting article is stable under greenhouse conditions for a predefined time period ranging between 2 weeks and 10 months, and optionally is biodegradable or bioerodible upon exposure to soil.

11. (canceled)

12. (canceled)

13. (canceled)

14. The article of claim 1, wherein said article is characterized by a predetermined degradation time suitable for supporting growth of a plant upon transplantation wherein said supporting comprises any one of: (i) preventing damage to a plant root, and (ii) facilitating root propagation and penetration of salts, water, and air through a wall of said article.

15. (canceled)

16. (canceled)

17. The article of claim 1, further comprising a coating layer, optionally wherein said coating layer comprises a biodegradable polymer.

18. (canceled)

19. A process for manufacturing the article of claim 1, comprising the steps of:
providing a mixture comprising the organic component and a curable resin, at a w/w ratio between 4:1 and 20:1, wherein a moisture content of the organic component is between 8 and 20% w/w, and wherein the mixture comprises a catalyst; and
molding said mixture under suitable conditions, thereby manufacturing said article.

20. The process of claim 19, wherein said suitable conditions comprise exposing said mixture to (i) a pressure and (ii) a thermal radiation.

21. The process of claim 20, wherein said thermal radiation is sufficient for curing said curable resin.

22. The process of claim 19, wherein said curable resin comprises furfuryl alcohol resin.
